(19) United States
(12) Patent Application Publication
(10) Pub. No.: US 2025/0183990 A1
(43) Pub. Date: Jun. 5, 2025

(54) RELAY APPARATUS

(71) Applicant: KYOCERA Corporation, Kyoto (JP)

(72) Inventors: Masato FUJISHIRO, Yokohama-shi (JP); Hiroyuki URABAYASHI, Yokohama-shi (JP)

(73) Assignee: KYOCERA Corporation, Kyoto (JP)

(21) Appl. No.: 19/043,676

(22) Filed: Feb. 3, 2025

Related U.S. Application Data
(63) Continuation of application No. PCT/JP2023/028076, filed on Aug. 1, 2023.

(30) Foreign Application Priority Data
Aug. 2, 2022 (JP) 2022-123626

(51) Int. Cl. H04B 7/155; H04W 28/02; H04W 72/0453; H04W 76/15

(52) U.S. Cl. CPC H04B 7/155; H04W 28/0215; H04W 72/0453; H04W 76/15

(57) ABSTRACT

A relay apparatus for use in a mobile communication system includes a relay that relays a radio signal transmitted between a base station and a user equipment, and a control terminal that performs wireless communication with the base station to control the relay. A first frequency used in a control link between the base station and the control terminal is different from a second frequency used in a backhaul link between the base station and the relay. The control terminal transmits information on the second frequency to the base station via the control link.

### RELATED APPLICATIONS

The present application is a continuation based on PCT Application No. PCT/JP2023/028076, filed on Aug. 1, 2023, which claims the benefit of Japanese Patent Application No. 2022-123626 filed on Aug. 2, 2022. The content of which is incorporated by reference herein in their entirety.

### TECHNICAL FIELD

The present disclosure relates to a relay apparatus used in a mobile communication system.

### BACKGROUND

In recent years, a mobile communication system of the fifth generation (5G) has been attracting attention. New Radio (NR), which is a radio access technology of the 5G system, is capable of wide-band transmission via a high frequency band as opposed to Long Term Evolution (LTE), which is a fourth-generation radio access technology.

Since radio signals (radio waves) in the high frequency band such as a millimeter wave band or a terahertz wave band have high rectilinearity, reduction of coverage of a base station is a problem. In order to solve such a problem, a repeater apparatus is attracting attention that is a kind of relay apparatus relaying radio signals between a base station and a user equipment, and can be controlled from a network (see, for example, Non-Patent Document 1). Such a repeater apparatus can extend the coverage of the base station while suppressing occurrence of interference by, for example, amplifying a radio signal received from the base station and transmitting the radio signal through directional transmission.

### CITATION LIST

### Non-Patent Literature

Non-Patent Document 1: 3GPP Contribution: RP-213700, “New SI: Study on NR Network-controlled Repeaters”

### SUMMARY

A relay apparatus of a first aspect is a relay apparatus for use in a mobile communication system, including a relay configured to relay a radio signal transmitted between a base station and a user equipment, and a control terminal configured to perform wireless communication with the base station to control the relay. A first frequency used in a control link between the base station and the control terminal is different from a second frequency used in a backhaul link between the base station and the relay. The control terminal transmits information on the second frequency to the base station via the control link.

A relay apparatus of a second aspect is a relay apparatus for use in a mobile communication system including a relay configured to relay a radio signal transmitted between a cell of a base station and a user equipment, and a control terminal configured to perform wireless communication with the base station to control the relay. The control terminal communicates information indicating a beam of a neighboring cell different from the cell with the base station via the control link.

A relay apparatus of a third aspect is a relay apparatus for use in a mobile communication system including a relay configured to relay a radio signal transmitted between a cell of a base station and a user equipment, and a control terminal configured to perform wireless communication with the base station to control the relay. The control terminal transmits information indicating a desired number of beams formed by the relay for an access link between the relay and the user equipment to the base station via the control link.

### BRIEF DESCRIPTION OF THE DRAWINGS

FIG. 1 is a diagram illustrating a configuration of a mobile communication system according to an embodiment.

FIG. 2 is a diagram illustrating a configuration of a protocol stack of a wireless interface of a user plane handling data.

FIG. 3 is a diagram illustrating a configuration of a protocol stack of a wireless interface of a control plane handling signaling (control signal).

FIG. 4 is a diagram illustrating an application scenario for a relay apparatus (NCR apparatus) according to a first embodiment.

FIG. 5 is a diagram illustrating an application scenario for the relay apparatus (NCR apparatus) according to the first embodiment.

FIG. 6 is a diagram illustrating a control method for the relay apparatus (NCR apparatus) according to the first embodiment.

FIG. 7 is a diagram illustrating a configuration example of a protocol stack in a mobile communication system including the relay apparatus (NCR apparatus) according to the first embodiment.

FIG. 8 is a diagram illustrating a configuration example of the relay apparatus (NCR apparatus) according to the first embodiment.

FIG. 9 is a diagram illustrating a configuration example of a base station (gNB) according to an embodiment.

FIG. 10 is a diagram illustrating an example of downlink signaling from the base station (gNB) to a control terminal (NCR-MT) according to the first embodiment.

FIG. 11 is a diagram illustrating an example of uplink signaling from the control terminal (NCR-MT) to the base station (gNB) according to the first embodiment.

FIG. 12 is a diagram illustrating an example of an overall operation sequence of the mobile communication system according to the first embodiment.

FIG. 13 is a diagram illustrating an example of beam sweeping in the mobile communication system according to the first embodiment.

FIG. 14 is a diagram illustrating an operation when frequencies are different between a control link and a backhaul link according to the first embodiment.

FIG. 15 is a diagram illustrating a first operation example when the frequencies are different between the control link and the backhaul link according to the first embodiment.

FIG. 16 is a diagram illustrating a second operation example when the frequencies are different between the control link and the backhaul link according to the first embodiment.

FIG. 17 is a diagram illustrating a third operation example when the frequencies are different between the control link and the backhaul link according to the first embodiment.

FIG. 18 is a diagram illustrating a fourth operation example when the frequencies are different between the control link and the backhaul link according to the first embodiment.

FIG. 19 is a diagram illustrating an operation example of inter-cell cooperation according to the first embodiment.

FIG. 20 is a diagram illustrating a first operation example of the inter-cell cooperation according to the first embodiment.

FIG. 21 is a diagram illustrating a second operation example of the inter-cell cooperation according to the first embodiment.

FIG. 22 is a diagram illustrating a beam sweeping operation example in the relay apparatus (NCR apparatus) according to the first embodiment.

FIG. 23 is a diagram illustrating the beam sweeping operation example in the relay apparatus (NCR apparatus) according to the first embodiment.

FIG. 24 is a diagram illustrating an example of an application scenario for a relay apparatus (RIS apparatus) according to a second embodiment.

FIG. 25 is a diagram illustrating a configuration example of the relay apparatus (RIS apparatus) according to the second embodiment.

### DESCRIPTION OF EMBODIMENTS

When a relay apparatus such as a repeater apparatus is controlled from a network, a control technique for specifically controlling the relay apparatus has not yet been established, and efficient coverage extension is currently difficult to perform using the relay apparatus.

An object of the present disclosure is to enable appropriate control of a relay apparatus that performs relay transmission between a base station and a user equipment.

A mobile communication system according to an embodiment is described with reference to the drawings. In the description of the drawings, the same or similar parts are denoted by the same or similar reference signs.

### (1) First Embodiment

A first embodiment will be described first. A relay apparatus according to the first embodiment is a repeater apparatus that can be controlled from a network.

### (1.1) Overview of Mobile Communication System

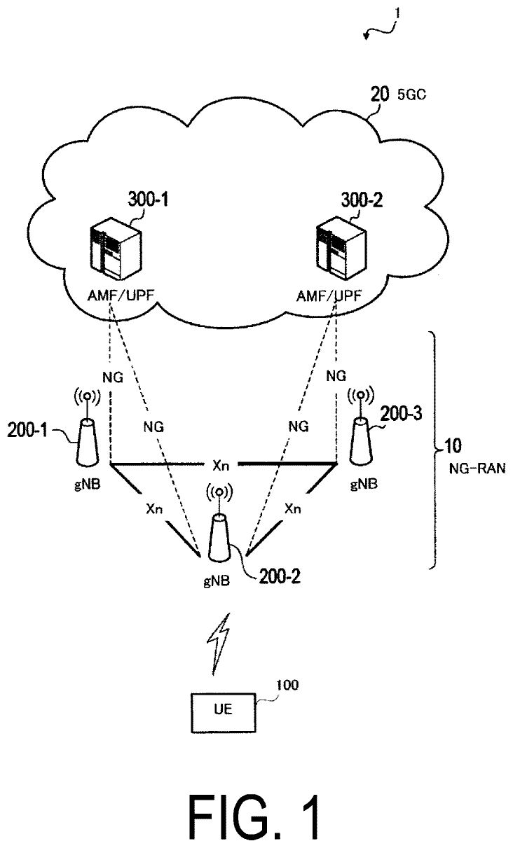

FIG. 1 is a diagram illustrating a configuration of a mobile communication system according to the first embodiment. The mobile communication system 1 complies with the 5th Generation System (5GS) of the 3rd Generation Partnership Project (3GPP) (registered trademark, the same applies hereinafter) standard. The description below takes the 5GS as an example, but a long term evolution (LTE) system may be at least partially applied to the mobile communication system. A sixth generation (6G) system may be at least partially applied to the mobile communication system.

The mobile communication system 1 includes a user equipment (UE) 100, a 5G radio access network (Next Generation Radio Access Network (NG-RAN)) 10, and a 5G Core Network (5GC) 20. The NG-RAN 10 may be hereinafter simply referred to as a RAN 10. The 5GC 20 may be simply referred to as a core network (CN) 20.

The UE 100 is a mobile wireless communication apparatus. The UE 100 may be any apparatus as long as the UE 100 is used by a user. Examples of the UE 100 include a mobile phone terminal (including a smartphone), a tablet terminal, a laptop PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes a base station (referred to as “gNB” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as one “frequency”).

The gNB can be connected to an evolved packet core (EPC) that is a core network of LTE. An LTE base station can also be connected to the 5GC. The LTE base station and the gNB can be connected via an inter-base station interface.

The 5GC 20 includes an access and mobility management function (AMF) and a user plane function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

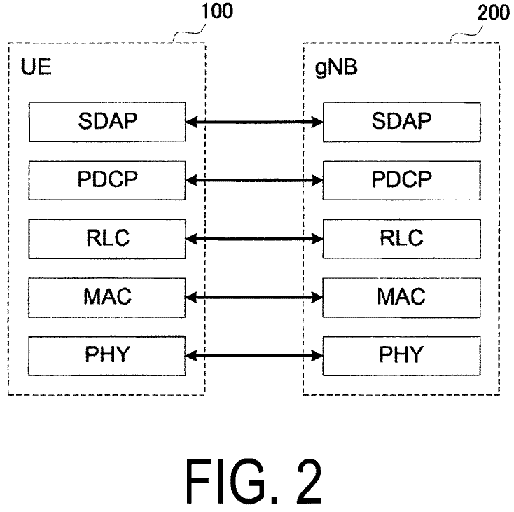

FIG. 2 is a diagram illustrating a configuration of a protocol stack of a wireless interface of a user plane handling data.

A wireless interface protocol of the user plane includes a physical (PHY) layer, a medium access control (MAC) layer, a radio link control (RLC) layer, a packet data convergence protocol (PDCP) layer, and a service data adaptation protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 performs blind decoding of the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The gNB 200 transmits a synchronization signal block (SSB: Synchronization Signal/PBCH block). For example, the SSB includes four consecutive Orthogonal Frequency Division Multiplex (OFDM) symbols, and a primary synchronization signal (PSS), a secondary synchronization signal (SSS), a physical broadcast channel (PBCH)/master information block (MIB), and a demodulation reference signal (DMRS) of the PBCH are disposed. A bandwidth of the SSB is, for example, a bandwidth of 240 consecutive subcarriers, that is, 20RB.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, modulation and coding schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow that is a unit in which a core network performs quality of service (QOS) control and a radio bearer that is a unit in which an access stratum (AS) performs QoS control. Note that, when the RAN is connected to the EPC, the SDAP need not be provided.

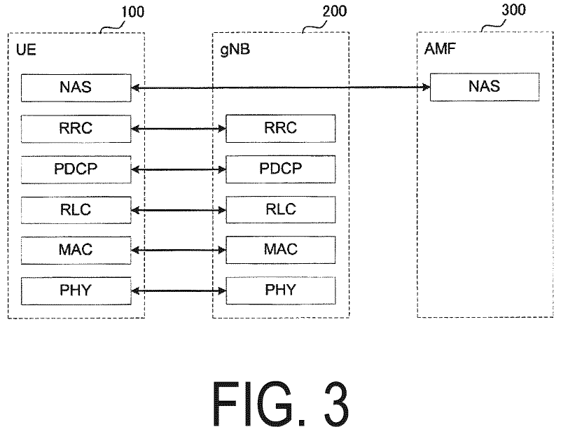

FIG. 3 is a diagram illustrating a configuration of a protocol stack of a wireless interface of a control plane handling signaling (a control signal).

The protocol stack of the wireless interface of the control plane includes a Radio Resource Control (RRC) layer and a Non-Access Stratum (NAS) layer instead of the SDAP layer illustrated in FIG. 2.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS layer higher than the RRC layer performs session management, mobility management, and the like. NAS signaling is transmitted between the NAS layer of the UE 100 and the NAS layer of an AMF 300A. Note that the UE 100 includes an application layer other than the protocol of the wireless interface. A layer lower than the NAS layer is referred to as an AS layer.

### (1.2) One Example of Application Scenario for Relay Apparatus

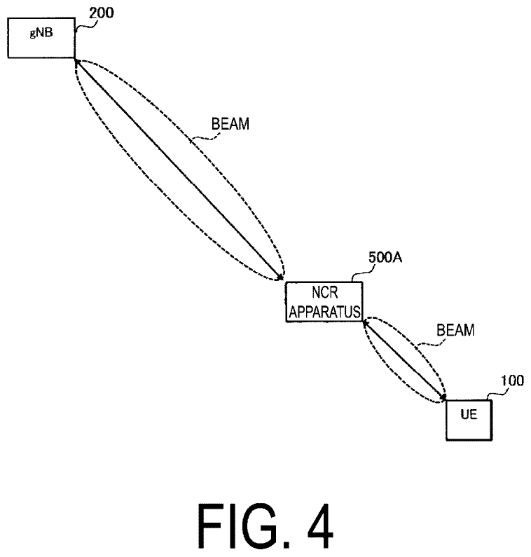

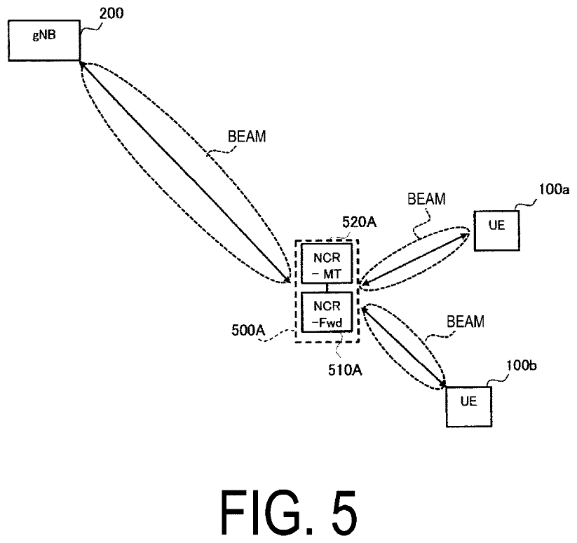

FIGS. 4 and 5 are diagrams illustrating an example of an application scenario of the NCR apparatus according to the first embodiment.

The 5G/NR is capable of wide-band transmission via a high frequency band compared to the 4G/LTE. Since radio signals in the high frequency band such as a millimeter wave band or a terahertz wave band have high rectilinearity, a problem is reduction of coverage of the gNB 200. In FIG. 4, the UE 100 may be located outside a coverage area of the gNB 200, for example, outside an area where the UE 100 can receive radio signals directly from the gNB 200. The UE 100 may not communicate with the gNB 200 within a line of sight because of obstacles existing between the gNB 200 and the UE 100.

As illustrated in FIG. 4, a repeater apparatus 500A that is a type of a relay apparatus relaying radio signals between the gNB 200 and the UE 100, and can be controlled from the network is introduced into the mobile communication system 1. Hereinafter, such a repeater apparatus is referred to as a network-controlled repeater (NCR) apparatus. Such a repeater apparatus may be referred to as a smart repeater apparatus.

For example, the NCR apparatus 500A amplifies a radio signal (radio wave) received from the gNB 200 and transmits the radio signal through directional transmission. To be specific, the NCR apparatus 500A receives a radio signal transmitted by the gNB 200 through beamforming. The NCR apparatus 500A amplifies the received radio signal without demodulation and modulation and transmits the amplified radio signal through the directional transmission. Here, the NCR apparatus 500A may transmit the radio signal with a fixed directivity (beam). The NCR apparatus 500A may transmit a radio signal with a variable (adaptive) directional beam. This can efficiently extend the coverage of the gNB 200. Although in the first embodiment, it is assumed that the NCR apparatus 500A is applied to downlink communication from the gNB 200 to the UE 100, the NCR apparatus 500A can also be applied to uplink communication from the UE 100 to the gNB 200.

As illustrated in FIG. 5, a new UE (hereinafter referred to as an “NCR-MT (Mobile termination)”) 100B that is a type of the control terminal for controlling the NCR apparatus 500A is introduced. That is, the NCR apparatus 500A includes an NCR-Fwd (Forward) 510A, which is a kind of a relay that relays a radio signal transmitted between the gNB 200 and the UE 100, concretely, changes a propagation state of the radio signal without demodulating or modulating the radio signal, and an NCR-MT 520A that performs wireless communication with the gNB 200 to control the NCR-Fwd 510A. Thus, the NCR-MT 520A controls the NCR apparatus 500A in cooperation with the gNB 200 by establishing a wireless connection to the gNB 200 and performing wireless communication to the gNB 200. Accordingly, efficient coverage extension can be realized using the NCR apparatus 500A. The NCR-MT 520A controls the NCR apparatus 500A according to control from the gNB 200.

The NCR-MT 520A may be configured separately from the NCR-Fwd 510A. For example, the NCR-MT 520A may be located near the NCR-Fwd 510A and may be electrically coupled to the NCR-Fwd 510A. The NCR-MT 520A may be coupled to the NCR-Fwd 510A by wire or wireless. The NCR-MT 520A may be configured to be integrated with the NCR-Fwd 510A. The NCR-MT 520A and the NCR-Fwd 510A may be fixedly installed at a coverage edge (cell edge) of the gNB 200, or on a wall surface or window of any building, for example. The NCR-MT 520A and the NCR-Fwd 510A may be installed in, for example, a vehicle and be movable. One NCR-MT 520A may control a plurality of NCR-Fwds 510A.

In the example illustrated in FIG. 5, the NCR apparatus 500A (NCR-Fwd 510A) dynamically or semi-statically changes a beam to be transmitted or received. For example, the NCR-Fwd 510A forms a beam toward each of a UE 100a and a UE 100b. The NCR-Fwd 510A may also form a beam toward the gNB 200. For example, in a communication resource between the gNB 200 and the UE 100a, the NCR-Fwd 510A transmits a radio signal received from the gNB 200 toward the UE 100a through beamforming and/or transmits a radio signal received from the UE 100a toward the gNB 200 through beamforming. In a communication resource between the gNB 200 and the UE 100b, the NCR-Fwd 510A transmits the radio signal received from the gNB 200 toward the UE 100b through beamforming and/or transmits the radio signal received from the UE 100b toward the gNB 200 through beamforming. Instead of or in addition to the beamforming, the NCR-Fwd 510A may perform null forming (so-called null steering) toward the UE 100 which is not a communication partner (not illustrated) and/or a neighboring gNB 200 (not illustrated) to curb interference.

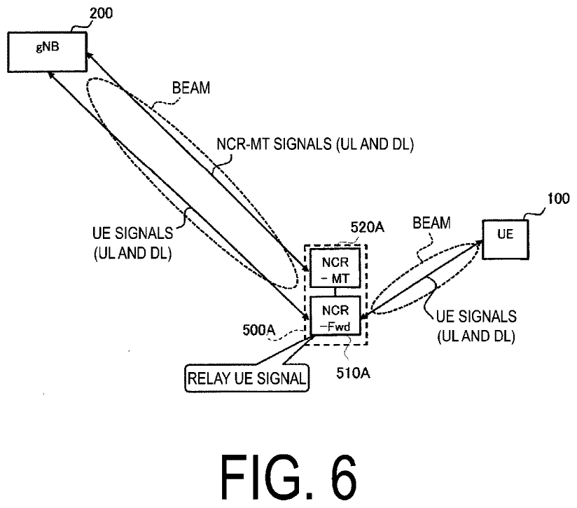

FIG. 6 is a diagram illustrating a control method for the NCR apparatus 500A according to the first embodiment. As illustrated in FIG. 6, the NCR-Fwd 510A relays a radio signal (referred to as a “UE signal”) between the gNB 200 and the UE 100. The UE signal includes an uplink signal transmitted from the UE 100 to the gNB 200 (referred to as “UE-UL signal”) and a downlink signal transmitted from the gNB 200 to the UE 100 (referred to as “UE-DL signal”). The NCR-Fwd 510A relays the UE-UL signal from the UE 100 to the gNB 200 and relays the UE-DL signal from the gNB 200 to the UE 100. The radio link between the NCR-Fwd 510A and the UE 100 is also referred to as an “access link”. The radio link between the NCR-Fwd 510A and the gNB 200 is also referred to as a “backhaul link”.

The NCR-MT 520A transmits and receives a radio signal (referred to herein as a “NCR-MT signal”) to and from the gNB 200. The NCR-MT signal includes an uplink signal transmitted from the NCR-MT 520A to the gNB 200 (referred to as an “NCR-MT-UL signal”), and a downlink signal transmitted from the gNB 200 to the NCR-MT 520A (referred to as an “NCR-MT-DL signal”). The NCR-MT-UL signal includes signaling for controlling the NCR apparatus 500A. The radio link between the NCR-MT 520A and the gNB 200 is also referred to as a “control link”.

The gNB 200 directs a beam to the NCR-MT 520A, based on the NCR-MT-UL signal from the NCR-MT 520A. Since the NCR apparatus 500A and the NCR-MT 520A are co-located, the beam is also eventually directed to the NCR-Fwd 510A when the backhaul link and the control link have the same frequency and the gNB 200 directs a beam to the NCR-MT 520A. The gNB 200 transmits the NCR-MT-DL signal and the UE-DL signal using the beam. The NCR-MT 520A receives the NCR-MT-DL signal. When the NCR-Fwd 510A and the NCR-MT 520A are at least partially integrated, a function (for example, antennas) for transmitting or receiving, or relaying UE signals and/or NCR-MT signals may be integrated in the NCR-Fwd 510A and the NCR-MT 520A. The beam includes a transmission beam and/or a reception beam. The beam is a general term for transmission and/or reception under control for maximizing power of a transmission wave and/or a reception wave in a specific direction by adjusting/adapting an antenna weight or the like.

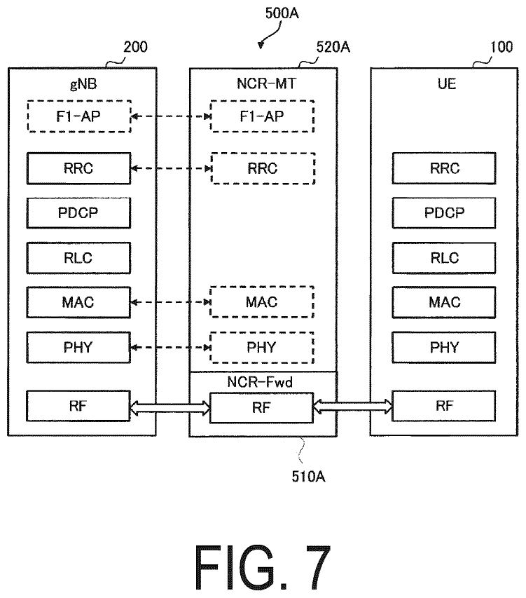

FIG. 7 is a diagram illustrating a configuration example of a protocol stack in the mobile communication system 1 including the NCR apparatus 500A according to the first embodiment. The NCR-Fwd 510A relays a radio signal transmitted and received between the gNB 200 and the UE 100. The NCR-Fwd 510A has a Radio Frequency (RF) function of amplifying and relaying a received radio signal, and performs directional transmission through beamforming (for example, analog beamforming).

The NCR-MT 520A includes at least one layer (entity) among PHY, MAC, RRC, and F1-Application Protocol (AP). The F1-AP is a type of a fronthaul interface. The NCR-MT 520A communicates downlink signaling and/or uplink signaling, which will be described below, with the gNB 200 through at least one of the PHY, the MAC, the RRC, and the F1-AP. When the NCR-MT 520A is a type or a part of the base station, the NCR-MT 520A may communicate with the gNB 200 through an AP of Xn (Xn-AP) which is an inter-base station interface. (1.3) Configuration Example of Relay Apparatus

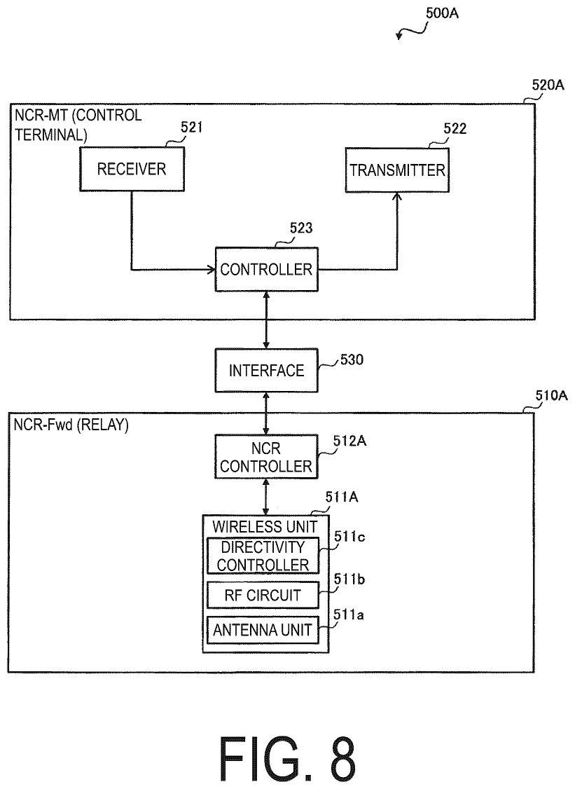

FIG. 8 is a diagram illustrating a configuration example of the NCR apparatus 500A that is the relay apparatus according to the first embodiment. The NCR apparatus 500A includes an NCR-Fwd 510A, an NCR-MT 520A, and an interface 530.

The NCR-Fwd 510A includes the wireless unit 511A and an NCR controller 512A. The wireless unit 511A includes an antenna unit 511a including a plurality of antennas (a plurality of antenna elements), an RF circuit 511b including an amplifier, and a directivity controller 511c that controls directivity of the antenna unit 511a. The RF circuit 511b amplifies and relays (transmits) radio signals transmitted and received by the antenna unit 511a. The RF circuit 511b may convert a radio signal, which is an analog signal, into a digital signal, and reconvert the digital signal into an analog signal after digital signal processing. The directivity controller 511c may perform analog beamforming through analog signal processing. The directivity controller 511c may perform digital beamforming through digital signal processing. The directivity controller 511c may perform analog and digital hybrid beamforming. The NCR controller 512A controls the wireless unit 511A in response to a control signal from the NCR-MT 520A. The NCR controller 512A may include at least one processor. The NCR controller 512A may output information on a capability of the NCR apparatus 500A to the NCR-MT 520A.

The NCR-MT 520A includes a receiver 521, a transmitter 522, and a controller 523. The receiver 521 performs various types of reception under control of the controller 523. The receiver 521 includes an antenna and a receiver. The receiver converts a radio signal received by the antenna (radio signal) into a baseband signal (a reception signal) and outputs the reception signal to the controller 523. The transmitter 522 performs various types of transmission under control of the controller 523. The transmitter 522 includes an antenna and a transmitter. The transmitter converts a baseband signal (a transmission signal) output by the controller 523 into a radio signal and transmits the radio signal from the antenna. The controller 523 performs various types of controls in the NCR-MT 520A. The controller 523 includes at least one processor and at least one memory. The memory stores a program to be executed by the processor and information to be used for processing by the processor. The processor may include a baseband processor and a central processing unit (CPU). The baseband processor performs modulation and demodulation, coding and decoding, and the like on a baseband signal. The CPU executes the program stored in the memory to thereby perform various types of processing. The controller 523 executes a function of layer of at least one of the PHY, the MAC, the RRC, and the F1-AP.

The interface 530 electrically couples the NCR-Fwd 510A to the NCR-MT 520A. The controller 523 of the NCR-MT 520A controls the NCR-Fwd 510A via the interface 530.

In the first embodiment, the receiver 521 of the NCR-MT 520A receives signaling (downlink signaling) used to control the NCR apparatus 500A from the gNB 200 through wireless communication. The controller 523 of the NCR-MT 520A controls the NCR apparatus 500A based on the signaling. This enables the gNB 200 to control the NCR-Fwd 510A via the NCR-MT 520A.

In the first embodiment, the controller 523 of the NCR-MT 520A may transmit the NCR capability information indicating the capability of the NCR apparatus 500A to the gNB 200 through wireless communication. The NCR capability information is an example of the uplink signaling from the NCR-MT 520A to the gNB 200. This enables the gNB 200 to ascertain the capability of the NCR apparatus 500A.

### (1.4) Configuration Example of Base Station

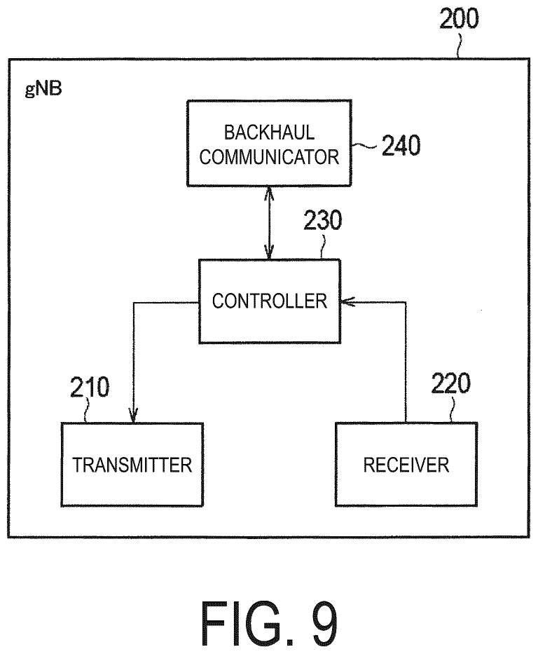

FIG. 9 is a diagram illustrating a configuration example of the gNB 200 according to the first embodiment. The gNB 200 includes a transmitter 210, a receiver 220, a controller 230, and a backhaul communicator 240.

The transmitter 210 performs various types of transmission under control of the controller 230. The transmitter 210 includes an antenna and a transmitter. The transmitter converts a baseband signal (a transmission signal) output by the controller 230 into a radio signal and transmits the resulting signal through the antenna. The receiver 220 performs various types of reception under control of the controller 230. The receiver 220 includes an antenna and a receiver. The receiver converts a radio signal received through the antenna into a baseband signal (a reception signal) and outputs the resulting signal to the controller 230. The transmitter 210 and the receiver 220 may be capable of beamforming using a plurality of antennas.

The controller 230 performs various types of controls for the gNB 200. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like on a baseband signal. The CPU executes the program stored in the memory to thereby perform various types of processing.

The backhaul communicator 240 is connected to a neighboring base station via the inter-base station interface. The backhaul communicator 240 is connected to the AMF/UPF 300 via the interface between a base station and the core network. Note that the gNB may include a Central Unit (CU) and a Distributed Unit (DU) (that is, functions are divided), and both units may be connected via an F1 interface.

In the first embodiment, the transmitter 210 of the gNB 200 transmits signaling (downlink signaling) used to control the NCR-Fwd 510A to the NCR-MT 520A through wireless communication. This enables the gNB 200 to control the NCR apparatus 500A via the NCR-MT 520A. In the first embodiment, the receiver 220 of the gNB 200 may receive the NCR capability information indicating the capability of the NCR apparatus 500A from the NCR-MT 520A through wireless communication.

### (1.5) One Example of Downlink Signaling

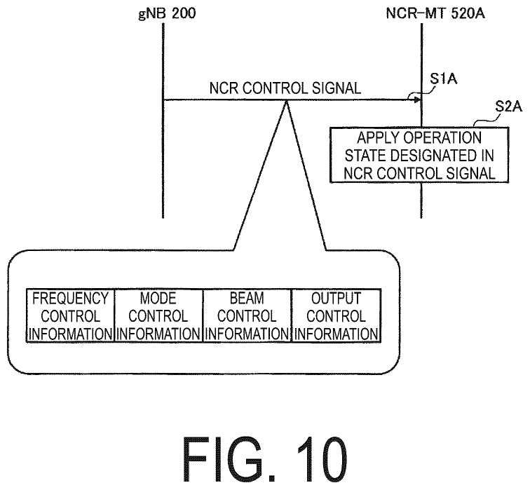

FIG. 10 is a diagram illustrating an example of the downlink signaling from the gNB 200 to the NCR-MT 520A according to the first embodiment.

The gNB 200 (transmitter 210) transmits downlink signaling to the NCR-MT 520A. The downlink signaling may be an RRC message that is RRC layer (that is, layer-3) signaling. The downlink signaling may be a MAC Control Element (CE) that is MAC layer (that is, layer-2) signaling. The downlink signaling may be downlink control information (DCI) that is PHY layer (that is, layer-1) signaling. The downlink signaling may be UE-specific signaling. The downlink signaling may be broadcast signaling. The downlink signaling may be a fronthaul message (for example, F1-AP message). When the NCR-MT 520A is a type or a part of the base station, the NCR-MT 520A may communicate with the gNB 200 through an AP of Xn (Xn-AP) which is an inter-base station interface.

For example, the gNB 200 (transmitter 210) transmits an NCR control signal for designating an operation state of the NCR apparatus 500A as the downlink signaling to the NCR-MT 520A having established a wireless connection to the gNB 200 (step S1A). The NCR control signal for designating the operation state of the NCR apparatus 500A may be a MAC CE that is signaling of the MAC layer (layer-2) or a DCI that is signaling of the PHY layer (layer-1). However, the gNB 200 (transmitter 210) may include the NCR control signal in an RRC Reconfiguration message that is a type of a UE-specific RRC message and transmit the message to the NCR-MT 520A. The downlink signaling may be a message of a layer (for example, an NCR application) higher than the RRC layer. The downlink signaling may be transmitting a message of a layer higher than the RRC layer encapsulated with a message of a layer equal to or lower than the RRC layer. The NCR-MT 520A (transmitter 522) may transmit a response message with respect to the downlink signaling from the gNB 200 in the uplink. The response message may be transmitted in response to the NCR apparatus 500A completing the configuration designated in the downlink signaling or receiving the configuration.

The NCR control signal may include frequency control information for designating a center frequency of a radio signal (for example, a component carrier) to be relayed by the NCR-Fwd 510A. When the NCR control signal received from the gNB 200 includes the frequency control information, the NCR-MT 520A (controller 523) controls the NCR-Fwd 510A such that the NCR-Fwd 510A relays a radio signal whose center frequency is indicated by the frequency control information as a target (step S2A). The NCR control signal may include a plurality of pieces of frequency control information for designating center frequencies different from each other. Since the NCR control signal includes the frequency control information, the gNB 200 can designate the center frequency of the radio signal to be relayed by the NCR-Fwd 510A via the NCR-MT 520A.

The NCR control signal may include mode control information for designating an operation mode of the NCR-Fwd 510A. The mode control information may be associated with the frequency control information (center frequency). The operation mode may be any one of a mode in which the NCR-Fwd 510A performs non-directional transmission and/or reception, a mode in which the NCR-Fwd 510A performs fixed-directional transmission and/or reception, a mode in which the NCR-Fwd 510A performs transmission and/or reception with a variable directional beam, and a mode in which the NCR-Fwd 510A performs Multiple Input Multiple Output (MIMO) relay transmission. The operation mode may be either a beamforming mode (that is, a mode in which improvement of a desired wave is emphasized) and a null steering mode (that is, a mode in which curbing of an interference wave is emphasized). When the NCR control signal received from the gNB 200 includes the mode control information, the NCR-MT 520A (controller 523) controls the NCR-Fwd 510A such that the NCR-Fwd 510A operates in the operation mode indicated by the mode control information (step S2A). Since the NCR control signal includes the mode control information, the gNB 200 can designate the operation mode of the NCR-Fwd 510A via the NCR-MT 520A.

Here, a mode in which the NCR apparatus 500A performs non-directional transmission and/or reception is a mode in which the NCR-Fwd 510A performs relay in all directions and may be referred to as an omnidirectional mode. The mode in which the NCR-Fwd 510A performs fixed-directional transmission and/or reception may be a directivity mode realized by one directional antenna, or may be a beamforming mode realized by applying fixed phase and amplitude control (antenna weight control) to a plurality of antennas. Any of these modes may be designated (configured) from the gNB 200 to the NCR-MT 520A. The mode in which the NCR-Fwd 510A performs transmission and/or reception with a variable directional beam may be a mode in which analog beamforming is performed, may be a mode in which digital beamforming is performed, or may be a mode in which hybrid beamforming is performed. The mode may be a mode for forming an adaptive beam specific to the UE 100. Any of these modes may be designated (configured) from the gNB 200 to the NCR-MT 520A. In the operation mode in which beamforming is performed, beam control information to be described below may be provided from the gNB 200 to the NCR-MT 520A. The mode in which the NCR apparatus 500A performs MIMO relay transmission may be a mode in which single-user (SU) spatial multiplexing is performed, may be a mode in which multi-user (MU) spatial multiplexing is performed, and/or may be a mode in which transmission diversity is performed. Any of these modes may be designated (configured) from the gNB 200 to the NCR-MT 520A. The operation mode may include a mode in which relay transmission by the NCR-Fwd 510A is turned on (activated) and a mode in which the relay transmission by the NCR-Fwd 510A is turned off (deactivated). Any of these modes may be designated (configured) from the gNB 200 to the NCR-MT 520A in the NCR control signal.

The NCR control signal may include beam control information for designating a transmission direction, a transmission weight, or a beam pattern for the NCR-Fwd 510A to perform directional transmission. The beam control information may be associated with the frequency control information (center frequency). The beam control information may include a precoding matrix indicator (PMI). The beam control information may include beam forming angle information. When the NCR control signal received from the gNB 200 includes the beam control information, the NCR-MT 520A (controller 523) controls the NCR-Fwd 510A such that the NCR-Fwd 510A forms a transmission directivity (beam) indicated by the beam control information (step S2A). Since the NCR control signal includes the beam control information, the gNB 200 can control the transmission directivity of the NCR apparatus 500A via the NCR-MT 520A.

The NCR control signal may include output control information for designating a degree at which the NCR-Fwd 510A amplifies a radio signal (amplification gain), or transmission power. The output control information may be information indicating a difference value (that is, a relative value) between a current amplification gain or transmission power and a target amplification gain or transmission power. When the NCR control signal received from the gNB 200 includes the output control information, NCR-MT 520A (controller 523) controls the NCR-Fwd 510A such that the amplification gain or transmission power is changed to an amplification gain or transmission power indicated by the output control information (step S2A). The output control information may be associated with the frequency control information (center frequency). The output control information may be information for designating any one of an amplification gain, a beamforming gain, and an antenna gain of the NCR-Fwd 510A. The output control information may be information for designating transmission power of the NCR-Fwd 510A.

When one NCR-MT 520A controls a plurality of NCR-Fwds 510A, the gNB 200 (transmitter 210) may transmit the NCR control signal to the NCR-MT 520A for each NCR-Fwd 510A. In this case, the NCR control signal may include an identifier of the corresponding NCR-Fwd 510A (NCR identifier). The NCR-MT 520A (controller 523) controlling the plurality of NCR-Fwds 510A determines the NCR-Fwd 510A to which the NCR control signal is applied, based on the NCR identifier included in the NCR control signal received from the gNB 200. The NCR identifier may be transmitted together with the NCR control signal from the NCR-MT 520A to the gNB 200 even when the NCR-MT 520A controls only one NCR-Fwd 510A.

Thus, the NCR-MT 520A (controller 523) controls the NCR-Fwd 510A based on the NCR control signal from the gNB 200. This enables the gNB 200 to control the NCR-Fwd 510A via the NCR-MT 520A.

### (1.6) Example of Uplink Signaling

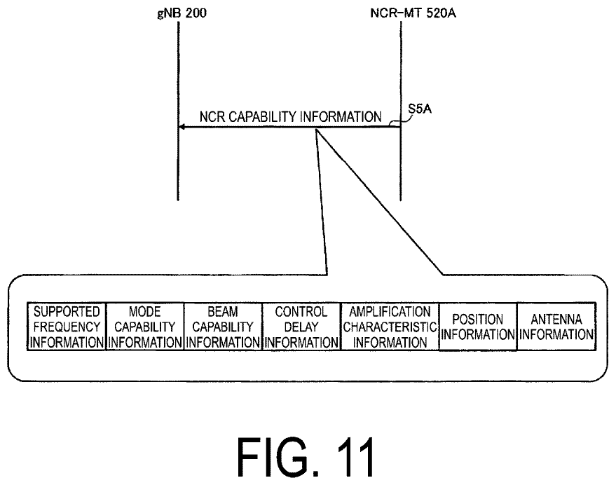

FIG. 11 is a diagram illustrating an example of the uplink signaling from the NCR-MT 520A to the gNB 200 according to the first embodiment.

The NCR-MT 520A (transmitter 210) transmits uplink signaling to the gNB 200. The uplink signaling may be an RRC message that is signaling of the RRC layer, may be a MAC CE that is signaling of the MAC layer, or may be uplink control information (UCI) that is signaling of the PHY layer. The uplink signaling may be a fronthaul message (for example, F1-AP message) or may be an inter-base station message (for example, an Xn-AP message). The uplink signaling may be a message of a layer (for example, an NCR application) higher than the RRC layer. The uplink signaling may be transmitting a message of a layer higher than the RRC layer encapsulated with a message of a layer equal to or lower than the RRC layer. That is, the uplink signaling stores a higher layer message in a lower layer container. The gNB 200 (transmitter 210) may transmit a response message with respect to the uplink signaling from the NCR-MT 520A in the downlink, and the NCR-MT 520A (receiver 521) may receive the response message.

For example, the NCR-MT 520A (transmitter 522) having established a wireless connection to the gNB 200 transmits the NCR capability information indicating the capability of the NCR apparatus 500A to the gNB 200 as the uplink signaling (step S5A). The NCR-MT 520A (transmitter 522) may include the NCR capability information in a UE Capability message or a UE Assistant Information message that is a type of the RRC message, and transmit the message to the gNB 200. The NCR-MT 520A (transmitter 522) may transmit the NCR capability information (NCR capability information and/or operation state information) to the gNB 200 in response to a request or inquiry from the gNB 200.

The NCR capability information may include supported frequency information indicating a frequency supported by the NCR-Fwd 510A. The supported frequency information may be a numerical value or index indicating a center frequency of the frequencies supported by the NCR-Fwd 510A and/or a numerical value or index indicating a range of the frequencies supported by the NCR-Fwd 510A. When the NCR capability information received from the NCR-MT 520A includes the supported frequency information, the gNB 200 (controller 230) can ascertain the frequency supported by the NCR-Fwd 510A, based on the supported frequency information. The gNB 200 (controller 230) may configure the center frequency of the radio signal targeted by the NCR apparatus 500A within the range of the frequencies supported by the NCR-Fwd 510A.

The NCR capability information may include mode capability information on the operation modes or switching between the operation modes that can be supported by the NCR-Fwd 510A. The operation mode may be, as described above, at least one of the mode in which the NCR-Fwd 510A performs non-directional transmission and/or reception, the mode in which the NCR-Fwd 510A performs fixed-directional transmission and/or reception, the mode in which the NCR-Fwd 510A performs transmission and/or reception with a variable directional beam, and a mode in which the NCR-Fwd 510A performs Multiple Input Multiple Output (MIMO) relay transmission. The operation mode may be either a beamforming mode (that is, a mode in which improvement of a desired wave is emphasized) and a null steering mode (that is, a mode in which curbing of an interference wave is emphasized). The mode capability information may be information indicating which operation mode among these operation modes the NCR-Fwd 510A can support. The mode capability information may be information indicating between which operation modes among these operation modes the mode switching is possible. When the NCR capability information received from the NCR-MT 520A includes the mode capability information, the gNB 200 (controller 230) can ascertain the operation modes and mode switching supported by the NCR-Fwd 510A, based on the mode capability information. The gNB 200 (controller 230) may configure the operation mode of the NCR-Fwd 510A within a range of the ascertained operation modes and mode switching.

The NCR capability information may include the beam capability information indicating a beam variable range, a beam variable resolution, or the number of variable patterns when the NCR-Fwd 510A performs transmission and/or reception with a variable directional beam. The beam capability information may be, for example, information indicating a variable range of a beam angle with respect to a horizontal direction or a vertical direction (for example, control of 30° to 90° is possible) or may be information indicating an absolute angle. The beam capability information may be represented by a direction and/or an elevation angle at which a beam is directed. The beam capability information may be information indicating an angle change for each variable step (for example, horizontal 5°/step and vertical 10°/step) or may be information indicating the number of variable steps (for example, horizontal 10 steps and vertical 20 steps). The beam capability information may be information indicating the number of variable patterns of the beam in the NCR-Fwd 510A (for example, a total of 10 patterns including beam patterns 1 to 10). When the NCR capability information received from the NCR-MT 520A includes the beam capability information, the gNB 200 (controller 230) can ascertain the beam angle change or beam patterns that can be supported by the NCR-Fwd 510A, based on the beam capability information. The gNB 200 (controller 230) may configure a beam of the NCR-Fwd 510A within a range of the ascertained beam angle change or beam patterns. These pieces of beam capability information may be null capability information. For the null capability information, the information indicates a null control capability when null steering is performed.

The NCR capability information may include control delay information indicating a control delay time in the NCR apparatus 500A. For example, the control delay information is information indicating a delay time (for example, 1 ms, 10 ms, . . . ) from a timing at which the UE 100 receives an NCR control signal or a timing at which the UE 100 transmits configuration completion for the NCR control signal to the gNB 200 until the UE 100 completes control (change of the operation mode or change of the beam) according to the NCR control signal. When the NCR capability information received from the NCR-MT 520A includes the control delay information, the gNB 200 (controller 230) can ascertain the control delay time in the NCR-Fwd 510A, based on the control delay information.

The NCR capability information may include amplification characteristic information on radio signal amplification characteristics or output power characteristics in the NCR-Fwd 510A. The amplification characteristic information may be information indicating an amplifier gain (dB), a beamforming gain (dB), and an antenna gain (dBi) of the NCR-Fwd 510A. The amplification characteristic information may be information indicating an amplification variable range (for example, 0 dB to 60 dB) in the NCR-Fwd 510A. The amplification characteristic information may be information indicating the number of steps (for example, 10 steps) of the amplification degrees that can be changed by the NCR-Fwd 510A or the amplification degree for each variable step (for example, 10 dB/step). The amplification characteristic information may be information indicating an output power variable range (for example, 0 dBm to 30 dBm) of the NCR-Fwd 510A. The amplification characteristic information may be information indicating the number of steps (for example, 10 steps) of the output power that can be changed by the NCR-Fwd 510A or the output power for each variable step (for example, 10 dBm/step or 10 dB/step).

The NCR capability information may include position information indicating an installation position of the NCR apparatus 500A. The position information may include any one or more of latitude, longitude, and altitude. The position information may include information indicating a distance and/or an installation angle of the NCR apparatus 500A with respect to the gNB 200. The installation angle may be a relative angle with respect to the gNB 200, or a relative angle with respect to, for example, north, vertical, or horizontal. The installation position may be position information about a place where the antenna unit 511a of the NCR-Fwd 510A is installed.

The NCR capability information may include antenna information indicating the number of antennas included in the NCR-Fwd 510A. The antenna information may be information indicating the number of antenna ports included in the NCR-Fwd 510A. The antenna information may be information indicating a degree of freedom of the directivity control (beam or null formation). The degree of freedom indicates how many beams can be formed (controlled) and is usually “(the number of antennas)−1”. For example, in the case of two antennas, the degree of freedom is one. In the case of two antennas, an 8-shaped beam pattern is formed, but the directivity control can be performed only in one direction, so that the degree of freedom is one.

When the NCR-MT 520A controls a plurality of NCR-Fwds 510A, the NCR-MT 520A (transmitter 522) may transmit the NCR capability information for each NCR-Fwd 510A to the gNB 200. In this case, the NCR capability information may include the number of NCR-Fwds 510A and/or an identifier of the corresponding NCR-Fwd 510A (NCR identifier). When the NCR-MT 520A controls a plurality of NCR-Fwds 510A, the NCR-MT 520A (transmitter 522) may transmit information indicating respective identifiers of the plurality of NCR-Fwds 510A and/or the number of the plurality of NCR-Fwds 510A. The NCR identifier may be transmitted together with the NCR capability information from the NCR-MT 520A to the gNB 200 even when the NCR-MT 520A controls only one NCR-Fwd 510A.

### (1.7) One Example of Overall Operation Sequence

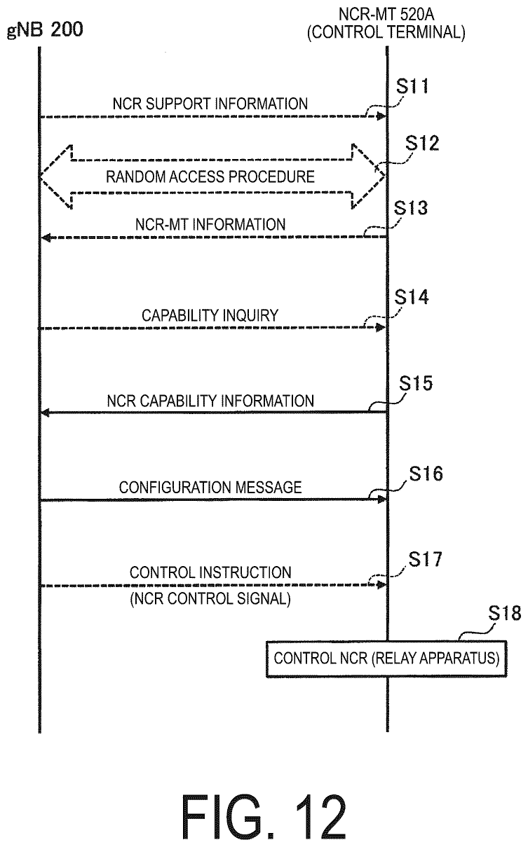

FIG. 12 is a diagram illustrating an example of an overall operation sequence of the mobile communication system 1 according to the first embodiment. In a sequence diagram referred to in the following embodiments, non-essential steps are indicated by dashed lines. Although description will be made in detail, “NCR” in FIG. 12 may be interpreted as “RIS”.

In step S11, the gNB 200 (transmitter 210) broadcasts NCR support information indicating that the gNB 200 supports the NCR-MT 520A. For example, the gNB 200 (transmitter 210) broadcasts a system information block (SIB) including the NCR support information. The NCR support information may be information indicating that the NCR-MT 520A is accessible. The gNB 200 (transmitter 210) may broadcast NCR non-support information indicating that the gNB 200 does not support the NCR-MT 520A. The NCR non-support information may be information indicating that the NCR-MT 520A is inaccessible.

In this stage, the NCR-MT 520A may be in the RRC idle state or RRC inactive state. The NCR-MT 520A (controller 523) having not established a wireless connection to the gNB 200 may determine that access to the gNB 200 is permitted in response to reception of the NCR support information from the gNB 200, and perform an access operation for establishing a wireless connection to the gNB 200. The NCR-MT 520A (controller 523) may regard the gNB 200 (cell) to which access is permitted as the highest priority and perform cell reselection.

On the other hand, when the gNB 200 does not broadcast the NCR support information (or when the gNB 200 broadcasts the NCR non-support information), the NCR-MT 520A (controller 523) having not established a wireless connection to the gNB 200 may determine that access (connection establishment) to the gNB 200 is not possible. This enables the NCR-MT 520A to establish a wireless connection only to the gNB 200 capable of handling the NCR-MT 520A.

When the gNB 200 is congested, the gNB 200 may broadcast access restriction information for restricting an access from the UE 100. However, the NCR-MT 520A can be regarded as a network-side entity, unlike a normal UE 100. Therefore, the NCR-MT 520A may ignore the access restriction information from the gNB 200. For example, when the NCR-MT 520A (controller 523) receives the NCR support information from the gNB 200, the NCR-MT 520A (controller 523) may perform an operation for establishing a wireless connection to the gNB 200 even when the gNB 200 broadcasts the access restriction information. For example, the NCR-MT 520A (controller 523) may not execute (or may ignore) unified access control (UAC). Alternatively, any one or both of access category/access identity (AC/AI) used in the UAC may be a special value indicating that the access is made by the NCR-MT.

In step S12, the NCR-MT 520A (controller 523) starts a random access procedure for the gNB 200. In the random access procedure, the NCR-MT 520A (transmitter 522) transmits a random access preamble (Msg1) and an RRC message (Msg3) to the gNB 200. In the random access procedure, the NCR-MT 520A (receiver 521) receives a random access response (Msg2) and an RRC message (Msg4) from the gNB 200.

In step S13, when the NCR-MT 520A (transmitter 522) establishes the wireless connection to the gNB 200, the NCR-MT 520A may transmit to the gNB 200 NCR-MT information indicating that the own UE itself is an NCR-MT. For example, the NCR-MT 520A (transmitter 522) includes the NCR-MT information in the message (for example, Msg1, Msg3, or Msg5) for a random access procedure to transmit the message to the gNB 200 during the random access procedure with the gNB 200. The gNB 200 (controller 230) can recognize that the accessing UE 100 is the NCR-MT 520A, based on the NCR-MT information received from the NCR-MT 520A, and exclude, for example, the NCR-MT 520A from the access restriction target (in other words, accept the access). When the random access procedure is completed, the NCR-MT 520A transitions from the RRC idle state or the RRC inactive state to the RRC connected state.

In step S14, the gNB 200 (transmitter 522) transmits a capability inquiry message for inquiring the capability of the NCR-MT 520A to the NCR-MT 520A. The NCR-MT 520A (receiver 521) receives the capability inquiry message.

In step S15, the NCR-MT 520A (transmitter 522) transmits a capability information message including the NCR capability information to the gNB 200. The capability information message may be an RRC message, for example, a UE Capability message. The gNB 200 (receiver 220) receives the capability information message. The gNB 200 (controller 230) ascertains the capability of the NCR apparatus 500A based on the received capability information message.

In step S16, the gNB 200 (transmitter 522) transmits a configuration message including various configurations regarding the NCR apparatus 500A to the NCR-MT 520A. The NCR-MT 520A (receiver 521) receives the configuration message. The configuration message is a type of the above-described downlink signaling. The configuration message may be an RRC message, for example an RRC reconfiguration message.

In step S17, the gNB 200 (transmitter 522) transmits the control instruction for designating the operation state of the NCR-Fwd 510A to the NCR-MT 520A. The control instruction may be the NCR control signal (for example, L1/L2 signaling) described above. The NCR-MT 520A (receiver 521) receives the control instruction. The NCR-MT 520A (controller 523) controls the NCR-Fwd 510A in response to a control instruction.

In step S18, the NCR-MT 520A controls the NCR apparatus 500A according to the configuration (and control instruction). The NCR-MT 520A may autonomously control the NCR apparatus 500A without depending on the control instruction from the gNB 200. For example, the NCR-MT 520A may autonomously control the NCR apparatus 500A based on a position of the UE 100 and/or information received from the UE 100 by the NCR-MT 520A.

### (1.8) Operation When Frequencies are Different Between Control Link and Backhaul Link

In the description of the above-described embodiments, it is mainly assumed that the control link (that is, the radio link between the NCR-MT 520A and the gNB 200) and the backhaul link (that is, the radio link between the NCR-Fwd 510A and gNB 200) have the same frequencies. However, it is desirable to assign a more stable radio link to the control link. Therefore, in the following description, it is assumed that a frequency used in the control link (hereinafter also referred to as a “first frequency”) is different from a frequency used in the backhaul link (hereinafter also referred to as a “second frequency”). The second frequency may be a frequency higher than the first frequency. For example, the first frequency is a frequency in a sub-6 band (also referred to as “FR (Frequency Range) 1”), and the second frequency is a frequency in a millimeter wave band (also referred to as “FR2”).

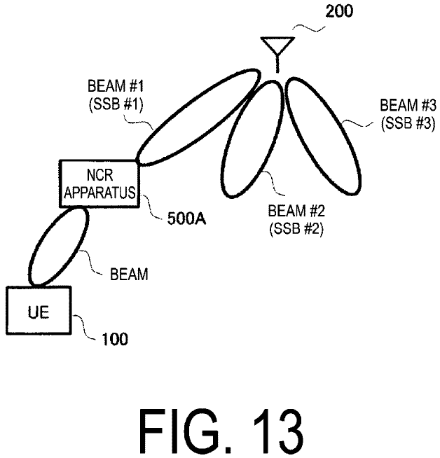

Under this assumption, the optimal beam for the NCR-MT 520A (that is, the optimal beam at the first frequency) is not optimal for the NCR-Fwd 510A operating at the second frequency due to different channel characteristics of the control link and the backhaul link. For example, as illustrated in FIG. 13, the gNB 200 performs beam sweeping in which transmission is performed while sequentially switching beams in different directions. In this case, the gNB 200 transmits a different SSB for each beam. The SSB is periodically transmitted from the gNB 200 into the cell as an SSB burst including a plurality of SSBs. An SSB index which is an identifier is added to each of a plurality of SSBs in one SSB burst. The SSBs are beamformed in different directions and transmitted. The NCR-MT 520A of the NCR apparatus 500A reports to the gNB 200 in which direction the reception quality of the beam is good in a random access channel (RACH) occasion associated with the SSB index. As a result, the gNB 200 can ascertain the optimum beam for the NCR-MT 520A, but cannot ascertain the optimum beam for the NCR-Fwd 510A.

Therefore, when the first frequency used in the control link and the second frequency used in the backhaul link are different, the NCR-MT 520A transmits information on the second frequency to the gNB 200 through the control link. This allows the gNB 200 to acquire information about the NCR apparatus 500A for the second frequency and to, for example, appropriately direct the beam to the NCR apparatus 500A at the second frequency.

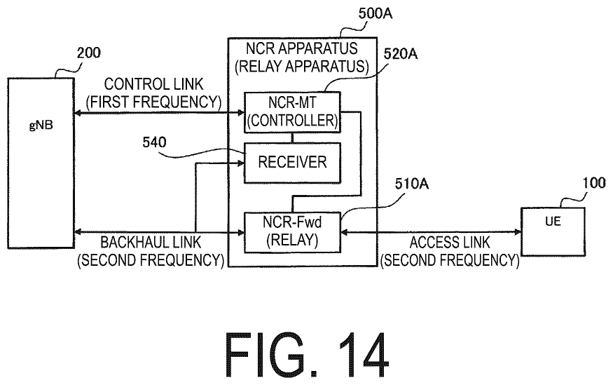

FIG. 14 is a diagram illustrating an operation when frequencies are different between a control link and a backhaul link. In the example illustrated, the NCR apparatus 500A includes a receiver 540 that receives radio signals transmitted at the second frequency from the gNB 200. The receiver 540 has reception processing of a radio signal (particularly, a function of receiving and demodulating an SSB). Specifically, the receiver 540 receives and demodulates the SSB transmitted at the second frequency from the gNB 200. The NCR-MT 520A transmits information on the second frequency to the gNB 200 via the control link based on the radio signals (in particular, the SSB) received by the receiver 540. Such information will be described in detail later.

The receiver 540 may share at least one of an antenna, a filter, and an amplifier with the NCR-Fwd 510A. The receiver 540 may be part of the NCR-Fwd 510A or may be part of the NCR-MT 520A. The receiver 540 may be provided independently of the NCR-Fwd 510A and the NCR-MT 520A. For example, the receiver 540 includes a down-converter that down-converts a frequency of a radio signal received by the antenna, an A/D converter that performs digital conversion processing on an output signal of the down-converter, a demodulator that performs demodulation processing on an output signal of the A/D converter, and a controller that controls reception processing thereof. When the receiver 540 is provided independently of the NCR-MT 520A, an interface may be provided between the receiver 540 and the NCR-MT 520A. The receiver 540 performs, for example, monitoring (beam measurement) of the SSB at the second frequency based on the control from the NCR-MT 520A. As a result of the monitoring, the receiver 540 may output, for example, an index of an optimal SSB and/or a beam measurement result to the NCR-MT 520A.

Hereinafter, an example in which beam information for identifying a beam is an SSB index on the assumption that a beam and an SSB (specifically, an SSB index) have a one to-one relationship will be mainly described. However, the beam may be associated with the CSI-RS. The beam information for identifying a beam may be a CSI-RS index.

### (1.8.1) First Operation Example

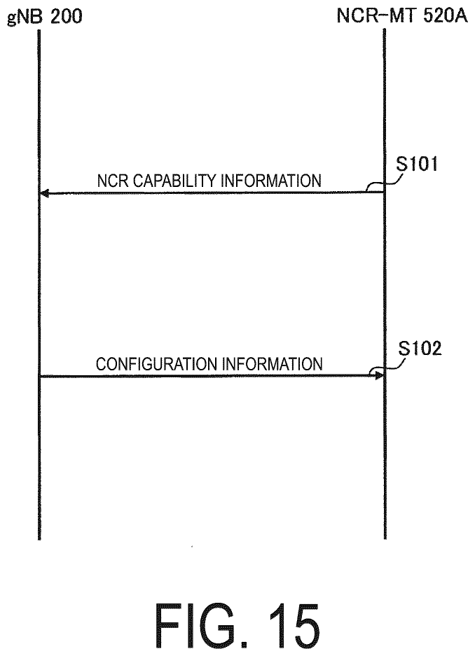

FIG. 15 is a diagram illustrating a first operation example when frequencies are different between a control link and a backhaul link. In the present first operation example, the NCR-MT 520A transmits capability information regarding the capability of the NCR-MT 520A to use the second frequency to the gNB 200 via the control link. The capability includes a capability of the NCR-MT 520A to establish a control link at the second frequency and/or a capability of the NCR-MT 520A to receive and/or process a radio signal transmitted at the second frequency from the gNB 200. The NCR-MT 520A may include capability information regarding the capability of the NCR-MT 520A to use the second frequency in the NCR capability information as illustrated in FIG. 11 and transmit the NCR capability information.

Thus, the NCR-MT 520A notifies the gNB 200 whether or not control link connection and/or beam reception is possible at the operating frequency of the NCR-Fwd 510A. Accordingly, the gNB 200 may ascertain whether the NCR-MT 520A is capable of control link connection and/or beam reception at the operating frequency of the NCR-Fwd 510A. The operating frequency of the NCR-Fwd 510A refers to the frequency of the radio signal relayed by the NCR-Fwd 510A, and is synonymous with the frequency of the backhaul link and the frequency of the access link.

As illustrated in FIG. 15, in step S101, the NCR-MT 520A transmits, to the gNB 200, the NCR capability information via the control link. The NCR capability information includes supported frequency information indicating a second frequency as a frequency supported by NCR-Fwd 510A (a frequency capable of relaying a radio signal).

The NCR capability information may include capability information on a capability of the NCR-MT 520A to use the second frequency. The capability information may include information indicating the center frequency of the second frequency that can be used by the NCR-MT 520A, or may include an identifier (for example, absolute radio-frequency channel number (ARFCN)) of the second frequency that can be used by the NCR-MT 520A.

The capability information may be information indicating whether or not the control link connection is possible at the operating frequency of the NCR-Fwd 510A, that is, whether or not the NCR-MT 520A can operate at the operating frequency of the NCR-Fwd 510A. The capability information may be information indicating whether or not SSB monitoring (SSB reception) is possible at the operating frequency of the NCR-Fwd 510A, that is, whether or not including the receiver 540. The capability information may be information indicating whether or not beam management is possible at the operating frequency of the NCR-Fwd 510A, for example, beam selection capability, beam monitoring capability, beam recovery capability, and the like. The capability information may be information indicating whether or not radio measurement in the operating frequency of the NCR-Fwd 510A is possible, for example, measurement capability and/or reporting capability of RSRP, RSRQ, SINR, or the like. The capability information may be information indicating whether simultaneous reception of the control link and the backhaul link of the NCR-MT 520A is possible. The capability information may be information indicating including the NCR-Fwd 510A having an operating frequency different from the operating frequency of the NCR-MT 520A.

In step S102, based on the capability information received from the NCR-MT 520A in step S101, the gNB 200 transmits to the NCR-MT 520A at least one of configuration information for handing over the NCR-MT 520A to the operating frequency of the NCR-Fwd 510A, configuration information for configuring the operating frequency of the NCR-Fwd 510A, configuration information for configuring the beam management of the operating frequency of the NCR-Fwd 510A, and configuration information for configuring the measurement of the operating frequencies of the NCR-Fwd 510A. The configuration information is transmitted from the gNB 200 to the NCR-MT 520A via the control link. The configuration information may be an information element included in the RRC message transmitted from the gNB 200 to the NCR-MT 520A, for example, the RRC reconfiguration message.

### (1.8.2) Second Operation Example

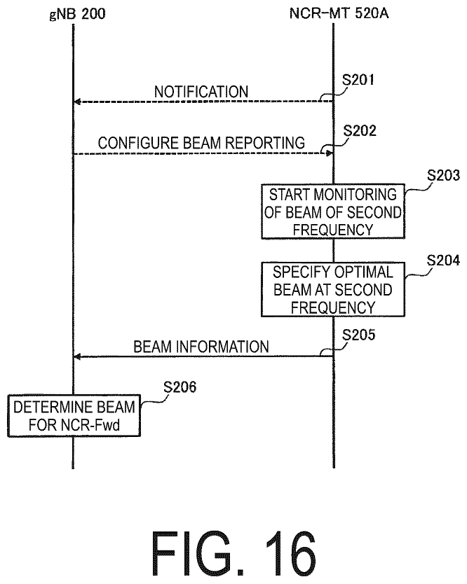

FIG. 16 is a diagram illustrating a second operation example when frequencies are different between a control link and a backhaul link. The present second operation example may be an operation based on the first operation example described above. In the present second operation example, the NCR-MT 520A transmits beam information indicating a beam satisfying a predetermined reception quality criterion (hereinafter also referred to as an “optimum beam”) at the second frequency or beam information indicating a beam not satisfying the predetermined reception quality criterion at the second frequency to the gNB 200 via the control link. Thus, the gNB 200 can ascertain the beam reception status of the NCR-Fwd 510A at the second frequency. The beam information includes an SSB index indicating a beam. The beam information may include a set of an SSB index and a measurement result (reception quality) of the beam.

For example, when the NCR-MT 520A establishes a control link at frequencies different from the operating frequency of the NCR-Fwd 510A, the NCR-MT 520A transmits the index of the optimal SSB at the operating frequency of the NCR-Fwd 510A to the gNB 200. The beam information may be included in the uplink signaling transmitted from the NCR-MT 520A to the gNB 200 through the control link, for example, in the RRC message or the MAC CE. The RRC message may be a UE Assistance Information message that is an existing RRC message, or a newly introduced RRC message for the NCR-MT 520A.

The NCR-MT 520A may transmit a set of the beam information and the frequency identifier (for example, ARFCN) to the gNB 200 via a control link. For example, the NCR-MT 520A transmits, to the gNB 200, information (for example, a list) that associates frequency identifiers indicating operating frequency of the NCR-Fwd 510A with an index of an optimal SSB.

As illustrated in FIG. 16, in step S201, the NCR-MT 520A may notify the gNB 200 that the control link is established at frequencies (first frequency) different from the operating frequency (second frequency) of the NCR-Fwd 510A.

In step S202, the gNB 200 may configure the beam report on the operating frequency of the NCR-Fwd 510A to the NCR-MT 520A.

In step S203, the NCR-MT 520A causes the receiver 540 to start monitoring the beam (SSB) at the operating frequency of the NCR-Fwd 510A. The receiver 540 may start the monitoring operation in response to a request from the NCR-MT 520A.

In step S204, the NCR-MT 520A specifies the SSB index of the optimal beam at the operating frequency of the NCR-Fwd 510A. The receiver 540 may specify the SSB index and notify the NCR-MT 520A of a specifying result. The receiver 540 may perform the SSB measurement and notify the NCR-MT 520A of the SSB index and the reception quality, and the NCR-MT 520A may specify the SSB index.

In step S205, the NCR-MT 520A transmits a notification including the beam information (SSB index) specified in step S204 to the gNB 200. The notification may include an identifier of the operating frequency of the NCR-Fwd 510A and/or an identifier of the NCR-Fwd 510A associated with the SSB index.

In step S206, the gNB 200 determines a beam (SSB index) for NCR-Fwd 510A based on the notification of the beam information in step S205.

When the control link is established at the same frequency es as the operating frequency (second frequency) of the NCR-Fwd 510A, the NCR-MT 520A may notify the gNB 200 of the establishment of the control link. In this case, the NCR-MT 520A may notify the gNB 200 of the optimum beam through the PRACH in the same or similar manner as the normal UE 100 without notification of the beam information in step S205. The gNB 200 may not perform the SSB monitor configuration in step S202.

### (1.8.3) Third Operation Example

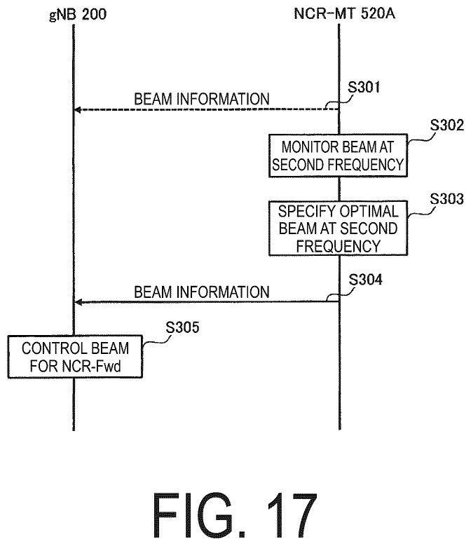

FIG. 17 is a diagram illustrating a third operation example when frequencies are different between a control link and a backhaul link. The present third operation example is an operation based on the first operation example and/or the second operation example described above. In the present third operation example, the NCR-MT 520A transmits beam information indicating the detected beam to the gNB 200 via the control link in response to detection of a beam having reception quality higher than that of the selected beam at the second frequency. For example, the NCR-MT 520A performs beam management after specifying the first optimum beam according to the second operation example described above, and transmits beam information indicating another optimum beam to the gNB 200. For example, the NCR-MT 520A may transmit to the gNB 200 a notification including the index of the selected SSB when the reception quality of the selected SSB is degraded or otherwise an optimal SSB is found at the operating frequency of the NCR-Fwd 510A.

As illustrated in FIG. 17, in step S301, the NCR-MT 520A specifies the SSB index of the optimum beam at the operating frequency of the NCR-Fwd 510A, and transmits the beam information (including the SSB index) to the gNB 200 (see the second operation example).

In step S302, the NCR-MT 520A continues beam (SSB) measurements using the receiver 540. Here, when the measured beam reception quality become lower than a threshold, the NCR-MT 520A may transmit beam information indicating that the reception quality of a current beam is lower to the gNB 200 (step S304). The threshold may be configured by the gNB 200. The threshold is, for example, a threshold of the RSRP.

In step S303, the NCR-MT 520A uses the receiver 540 to specify the SSB index of the beam with a higher quality than the current beam. When the NCR-MT 520A specifies the SSB index of another good quality beam (for example, when beam recovery is completed), the NCR-MT 520A may transmit beam information including the specified SSB index of the beam to the gNB 200 (step S304). The determination may be performed using a threshold. The threshold may be configured by the gNB 200. The threshold is, for example, a threshold of the RSRP. The NCR-MT 520A may determine that the beam is a higher quality beam than the current beam when the RSRP of the other beam becomes better (higher) than the threshold or when a ratio (difference) between the RSRP of the current beam and the RSRP of the other beam becomes higher than the threshold.

In step S305, the gNB 200 determines transmission weights of appropriate beams at the operating frequency (second frequency) of the NCR-Fwd 510A, based on the notification of the beam information in step S304.

### (1.8.4) Fourth Operation Example

The beam management according to the second operation example and/or the third operation example described above can specify an approximately optimum beam (weight) for the backhaul link. Here, when general hybrid beamforming is assumed, rough beam control is performed by analog beamforming by the beam management. Thereafter, processing such as forming a different beam for each link (UE 100) is performed by increasing the accuracy of a beam (weight) by digital beamforming (digital precoding). In the case of FDD, the gNB 200 performs precoding based on CSI feedback from the UE 100. In the case of TDD, the gNB 200 performs precoding according to the SRS from the UE 100.

However, the NCR apparatus 500A, which only includes the receiver 540 at the operating frequencies (second frequency) of the NCR-Fwd 510A, cannot transmit CSI feedback or SRS at the second frequency. Therefore, optimal beamforming may not be performed in the backhaul link (second frequency).

Therefore, the NCR-MT 520A measures a channel state in the backhaul link (second frequency) and transmits feedback information (CSI feedback) indicating the measured channel state to the gNB 200 via the control link (first frequency). This makes it possible to perform optimal beamforming in the backhaul link (second frequency). The NCR-MT 520A may transmit the CSI feedback information through a physical up-link control channel (PUCCH) or a PUSCH, or may transmit the CSI feedback information through a MAC CE or an RRC message.

The CSI feedback information may include information for determining the MCS of the beam. The type of the CSI feedback information may include channel quality information (CQI), a precoding matrix indicator (PMI), a CSI-RS resource indicator (CRI), an SS/PBCH resource block indicator (SSBRI), a layer indicator (L1), a rank indicator (RI), and a L1-RSRP.

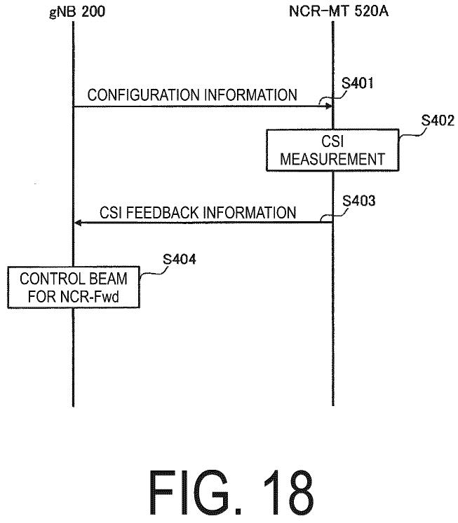

FIG. 18 is a diagram illustrating a fourth operation example when frequencies are different between a control link and a backhaul link. The fourth operation example may be an operation based on at least one of the first to third operation examples described above.

As illustrated in FIG. 18, in step S401, the gNB 200 performs, on the NCR-MT 520A, a configuration of CSI measurement at the second frequency (operating frequency of the NCR-Fwd 510A) different from the frequency of the control link (first frequency) and a configuration of the feedback by the control link. The gNB 200 may transmit an RRC message (for example, RRC Reconfiguration message) including the configuration information to the NCR-MT 520A. The gNB 200 may perform a configuration of the CSI feedback (for example, report configuration) as part of the measurement configuration (Measurement Config.). The gNB 200 may configure the type of the CSI feedback information in the NCR-MT 520A. The NCR-MT 520A may notify configuration content in the NCR-Fwd 510A.

When the NCR-MT 520A performs the CSI feedback in the PUCCH, the gNB 200 may configure, in the NCR-MT 520A, PUCCH resources for transmitting the CSI feedback information indicating the channel state of the backhaul link, in addition to the PUCCH resources for transmitting the CSI feedback information indicating the channel state of the control link. When the NCR-MT 520A performs CSI feedback in the PUSCH, the NCR-MT 520A may transmit uplink control information (UCI) including CSI feedback information, which is included in the PUSCH, without performing PUCCH transmission when the transmission timings of the PUCCH and the PUSCH match each other. When the NCR-MT 520A performs the CSI feedback through the MAC CE or the RRC message, the gNB 200 may configure, in the NCR-MT 520A, information (LCID, measurement ID, or the like) for identifying a CSI feedback cycle and/or the CSI feedback of the NCR-Fwd 510A.

In step S402, the NCR-MT 520A performs CSI measurement (channel estimation or the like) of the backhaul link (second frequency) using a reference signal received by the receiver 540 at the operating frequency of the NCR-Fwd 510A. The NCR-MT 520A, for example, measures the CSI-RS for each configured feedback cycle and calculates the CSI from the measurement result. The NCR-MT 520A may perform CSI measurement using a CSI-RS and/or a demodulation reference signal (DM-RS) received by the receiver 540. When the NCR-Fwd 510A performs CSI measurement, the NCR-Fwd 510A may notify the NCR-MT 520A of a measurement result. For example, the NCR-Fwd 510A may notify the NCR-MT 520A of the CSI feedback information, or may notify the NCR-MT 520A of the CSI measurement result to derive the CSI feedback information on the NCR-MT 520A side.

In step S403, the NCR-MT 520A transmits CSI feedback information to the gNB 200 according to the configuration in step S401.

When CSI feedback is performed in the PUCCH, the NCR-MT 520A transmits UCI including CSI feedback information regarding the backhaul link (second frequency). When the CSI feedback is performed in the PUSCH, the NCR-MT 520A transmits the UCI including the CSI feedback information regarding the backhaul link (second frequency) on the PUSCH. When the CSI feedback is performed in the MAC CE, the NCR-MT 520A transmits the MAC CE having the same or similar bit arrangement as that of the UCI in each configured cycle. The MAC CE may include at least one of the identifier of the NCR-Fwd 510A, the identifier of the operating frequency of the NCR-Fwd 510A, an LCID in the MAC sub-header, and a cell ID of a serving cell of the NCR-Fwd 510A. These identifiers may be pointers to a separately configured list. For example, an adjacent frequency list is referred to, and the number of an entry in the list is indicated. When the CSI feedback is performed in the RRC, the NCR-MT 520A may encapsulate the UCI including the CSI feedback information regarding the backhaul link (second frequency) into the RRC message and transmit the RRC message in each configured cycle, or may define the CSI feedback information as an information element (IE) like a normal message (Measurement Report or the like).

When the feedback cycle is configured, the NCR-MT 520A may start (or restart) a timer for each feedback transmission and transmit the feedback when the timer expires. The NCR-MT 520A may not transmit feedback (that is, transmission is not allowed) even when the CSI information from the NCR-Fwd 510A is notified while the timer is operating. In this case, the NCR-MT 520A may store (buffer) the CSI information. When the NCR-MT 520A is notified of new CSI information and old CSI information is stored (buffered), the old CSI information may be discarded or replaced with new CSI information.

In step S404, the gNB 200 performs beam control (precoding) for the NCR-Fwd 510A using the CSI feedback information in step S403.

### (1.9) Operation Examples for Inter-Cell Cooperation

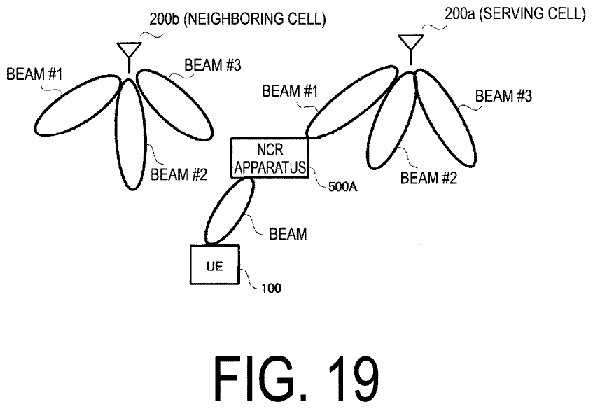

FIG. 19 is a diagram illustrating an operation example of the inter-cell cooperation. In the present operation example, it is not assumed that the NCR-MT 520A and the NCR-Fwd 510A operate at different frequencies. The NCR apparatus 500A (the NCR-MT 520A) is in the RRC connected state with the cell of the gNB 200a as the serving cell. The NCR apparatus 500A may receive beams of neighboring cells, which are cells of gNB 200a, as interfering waves. Therefore, it is desirable to perform coordination of beam sweeping between cells to reduce interference of beams (SSB) in the entire system.

The NCR-Fwd 510A, which relays a radio signal transmitted between the cell (serving cell) of the gNB 200a and the UE 100, communicates information indicating the beam of the neighboring cell to the gNB 200a via the control link. For example, the NCR-MT 520A receives beam information indicating the beam of the neighboring cell from the serving cell via the control link, and performs processing of receiving the beam of the neighboring cell based on the received information. The NCR-MT 520A may specify an interference beam that is a beam of a neighboring cell and is an interference source, and transmit information indicating the specified interference beam to the gNB 200 via the control link.

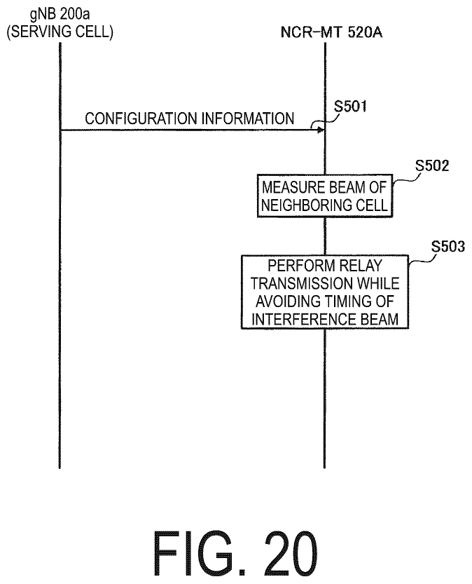

FIG. 20 is a diagram illustrating a first operation example of the inter-cell cooperation.

In step S501, the gNB 200a may configure the SSB measurement of the neighboring gNB 200b (neighboring cell) to the NCR-MT 520A.

In step S502, the NCR-MT 520A measures the beam (SSB) of the neighboring gNB 200b (neighboring cell) and specifies the SSB transmission timing of the neighboring cell.

In step S503, the NCR-MT 520A controls the NCR-Fwd 510A so as to avoid the timing specified in step S502 and relay the SSB of the gNB 200a (serving cell). The NCR-MT 520A controls the NCR-Fwd 510A so as not to perform a relay operation at a timing at which SSB transmission conflicts between the serving cell and the neighboring cell. The NCR-MT 520A may notify the gNB 200a (serving cell) of the timing specified in step S502.

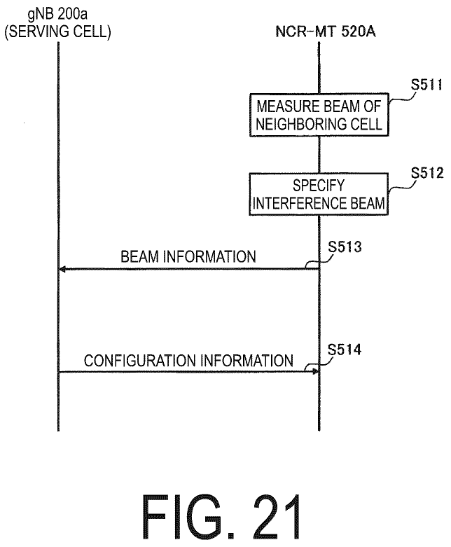

FIG. 21 is a diagram illustrating a second operation example of the inter-cell cooperation.

In step S511, the NCR-MT 520A measures the SSB of the neighboring gNB 200b (neighboring cell) at the operating frequency of the NCR-Fwd 510A. The NCR-MT 520A may specify the cell ID associated with the observed SSB.

In step S512, the NCR-MT 520A specifies a beam (SSB) that is an interference source. The NCR-MT 520A may specify all received SSBs as interference sources. The NCR-MT 520A may specify only an SSB having a reception level (RSRP) equal to or higher than a threshold as an interference source. The threshold may be configured by the gNB 200 in advance.

In step S513, the NCR-MT 520A transmits beam information on a beam of the neighboring gNB 200b (neighboring cell) to the gNB 200a (serving cell). The beam information includes at least one of the SSB index specified as the interference source in step S512, a corresponding cell ID, and information indicating a timing at which the interference occurs. The beam information may include an SSB index of the own gNB 200a (serving cell) that does not become an interference source. For example, the NCR-MT 520A may specify, for the SSB of the serving cell, a timing at which the SSB of the neighboring cell does not face in the direction of the NCR-Fwd 510A (a timing without interference source), and notify the serving cell of the SSB index associated with the timing.

In step S514, based on the notification of the beam information in step S513, the gNB 200a determines an SSB index for the NCR-Fwd 510A to perform beam sweeping, and configures the SSB index to the NCR-MT 520A. The NCR-MT 520A controls the NCR-Fwd 510A to perform the relay operation of the configured SSB (configured timing).

### (1.10) Example of Beam Sweeping Operation by Relay Apparatus

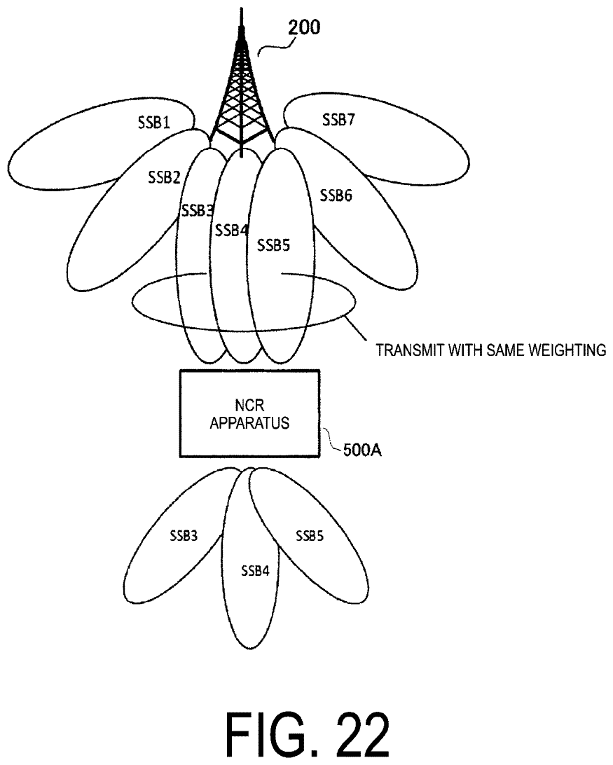

FIG. 22 is a diagram illustrating a beam sweeping operation example in the relay apparatus (NCR apparatus 500A). The gNB 200 transmits a plurality of beams (beams of SSB3 to SSB5 in the illustrated example) with the same transmission weight in the direction of the NCR apparatus 500A for the backhaul link. The NCR apparatus 500A transmits the plurality of beams with different transmission weights in different directions for the access link. Under such a premise, the NCR-MT 520A may transmit information indicating the desired number of beams formed by the NCR-Fwd 510A for the access link to the gNB 200 via the control link.

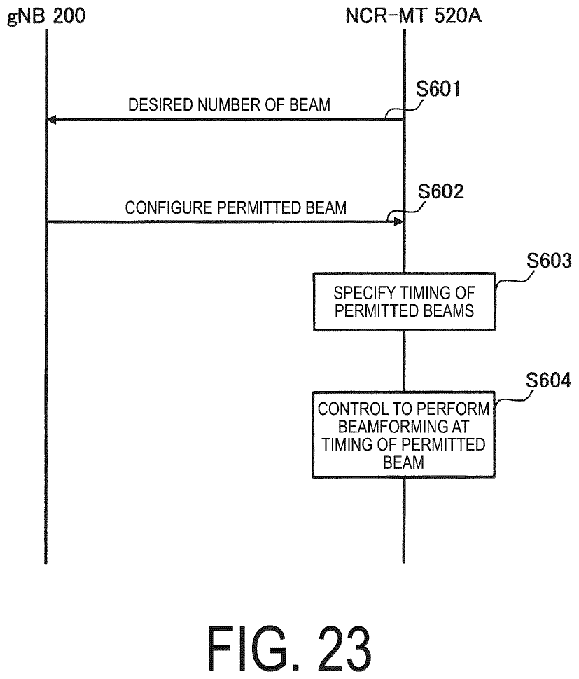

FIG. 23 is a diagram illustrating an example of a beam sweeping operation in the NCR apparatus 500A.

In step S601, the NCR-MT 520A requests the number of SSBs (the desired number of beams) for performing beam sweeping in the NCR-Fwd 510A from the gNB 200. The NCR-MT 520A may transmit an RRC message including information on the desired number of beams to the gNB 200 via a control link.

In step S602, the gNB 200 notifies the NCR-MT 520A of the SSB index at which the NCR apparatus 500A can apply beam sweeping. The gNB 200 may notify the NCR-MT 520A of the number of SSBs permitted to be used and a list of SSB indexes permitted to be used. The gNB 200 may notify the NCR-MT 520A of a list of SSB indexes that are not permitted to be used (the NCR apparatus 500A not allowed to be involved). The gNB 200 may transmit an RRC message including information thereof to the NCR-MT 520A via the control link.

In step S603, the NCR-MT 520A specifies the timing corresponding to each SSB index notified in step S602.

In step S604, the NCR-MT 520A controls the NCR-Fwd 510A so as to form a different beam for each SSB timing (for each SSB index) specified in step S603. Here, the NCR-Fwd 510A optimizes beam formation at each SSB timing according to its own capability such as beam control resolution or beam width and the number of permitted beams. For example, as the capability of the NCR-Fwd 510A, it is assumed that the beam direction can be controlled every 5° in a range of 360°, and the beam width can be adjusted every 10° in a range of 10° to 90°, and it is assumed that the number of beams (SSBs) permitted in step S602 is eight. In this case, the beams of the NCR-Fwd 510A are optimized as follows: “SSB #1: beam direction θ degrees and beam width 45 degrees”, “SSB #2: beam direction 45 degrees and beam width 45 degrees”, . . . , “SSB #8: beam direction 315 degrees and beam width 45 degrees”. The NCR-MT 520A performs beam forming according to NCR control information from the gNB 200 for timings other than the SSB timing specified in step S603.

### (2) Second Embodiment

Differences between a second embodiment and the first embodiment described above will be mainly described. The overview of a mobile communication system 1 and a configuration of a gNB 200 according to the second embodiment are the same as and/or similar to those of the first embodiment described above.

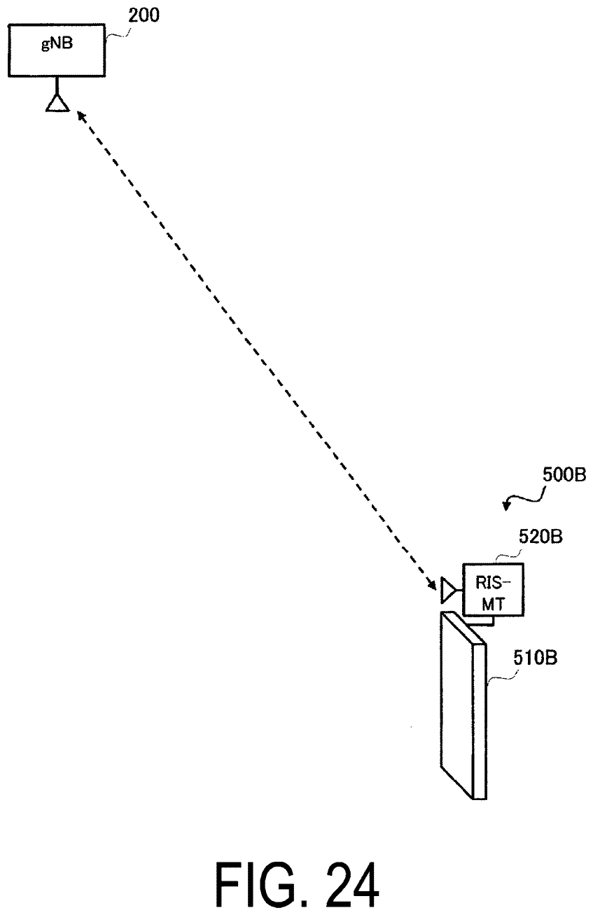

As illustrated in FIG. 24, a relay apparatus according to the second embodiment is a reconfigurable intelligent surface (RIS) apparatus 500B that changes a propagation direction of an incident radio wave (radio signal) through reflection or refraction. The “NCR” in the first embodiment described above may be interpreted as the “RIS”.

The RIS is a type of relay (hereinafter referred to as “RIS-Fwd”) that can perform beamforming (directional control) in a same or similar manner as NCR by changing the properties of metamaterial. In the case of the RIS, a range (distance) of the beam may be changeable by controlling a reflection direction or a refraction direction of each unit element. For example, this is a configuration in which the reflection direction or refraction direction of each unit element can be controlled and a near UE can be focused on (the beam is directed to the near UE) or a far UE can be focused on (the beam is directed to the far UE).

The RIS apparatus 500B includes a new UE (hereinafter referred to as “RIS-MT”) 520B which is a control terminal for controlling the RIS-Fwd 510B. The RIS-MT 520B controls the RIS-Fwd 510B in cooperation with the gNB 200 by establishing a wireless connection to the gNB 200 and performing wireless communication with the gNB 200. The RIS-Fwd 510B may be a reflective RIS. Such an RIS-Fwd 510B reflects an incident radio wave to change a propagation direction of the radio wave. Here, a reflection angle of the radio wave can be variably configured. The RIS-Fwd 510B reflects radio waves incident from the gNB 200 toward the UE 100. The RIS-Fwd 510B may be a transmissive RIS. Such an RIS-Fwd 510B refracts an incident radio wave to change the propagation direction of the radio wave. Here, a refraction angle of the radio wave can be variably configured.

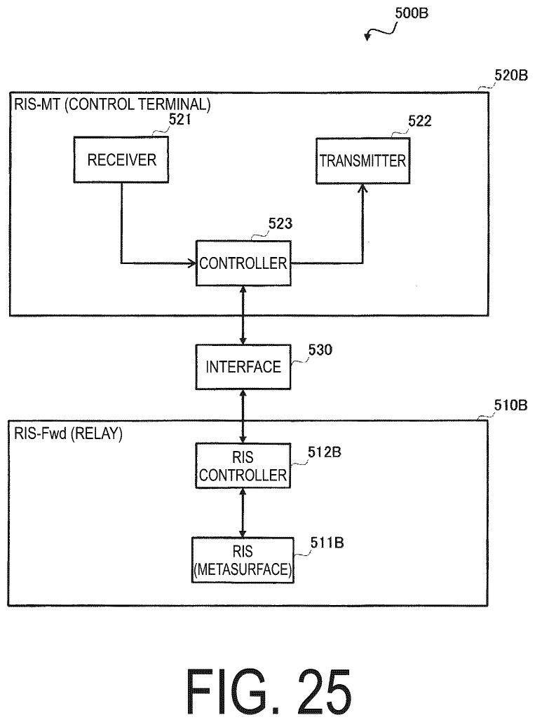

FIG. 25 is a diagram illustrating configuration examples of the RIS-Fwd 510B and the RIS-MT 520B according to the second embodiment. The RIS-MT 520B includes a receiver 521, a transmitter 522, and a controller 523. Such a configuration is the same as or similar to that in the first embodiment described above. The RIS-Fwd 510B includes a RIS 511B and a RIS controller 512B. The RIS 511B is a metasurface configured using a metamaterial. For example, the RIS 511B is configured by disposing very small structures in an array form with respect to a wavelength of a radio wave, and can arbitrarily design a direction or beam shape of a reflected wave by forming the structures in different shapes depending on a disposition position. The RIS 511B may be a transparent dynamic metasurface. The RIS 511B may be configured by stacking a transparent glass substrate on transparent version of a metasurface substrate on which a large number of small structures are regularly disposed, and may be capable of dynamically controlling three patterns of a mode of transmitting an incident radio wave, a mode of transmitting a part of a radio wave and reflecting a part thereof, and a mode of reflecting all radio waves by minutely moving the stacked glass substrate. The RIS controller 512B controls the RIS 511B in response to a RIS control signal from the controller 523 in the RIS-MT 520B. The RIS controller 512B may include at least one processor and at least one actuator. The processor interprets a RIS control signal from the controller 523 in the RIS-MT 520B to drive the actuator in response to the RIS control signal.

### (3) Other Embodiments

In the above-described embodiments, the frequency may be read as a cell and/or a bandwidth portion (BWP). The BWP is a part of a frequency band of a cell.

The above-described operation flows are not limited to being carried out separately and independently, and two or more operation flows can be combined and carried out. For example, some steps of one operation flow may be added to another operation flow or some steps of one operation flow may be replaced with some steps of another operation flow. In each flow, all steps may not be necessarily performed, and only some of the steps may be performed.

In the embodiment described above, an example in which the base station is an NR base station (gNB) has been described. However, the base station may be an LTE base station (an eNB). The base station may be a relay node such as an Integrated Access and Backhaul (IAB) node. The base station may be a distributed unit (DU) of the IAB node.

A program causing a computer to execute each of the processes performed by the UE 100 (NCR-MT 520A, RIS-MT 520B) or the gNB 200 may be provided. The program may be recorded on a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 or the gNB 200 may be implemented as a semiconductor integrated circuit (chipset, System on a chip (SoC)).

The phrases “based on” and “depending on/in response to” used in the present disclosure do not mean “based only on” and “only depending on/in response to,” unless specifically stated otherwise. The phrase “based on” means both “based only on” and “based at least in part on”. The phrase “depending on” means both “only depending on” and “at least partially depending on”. The terms “include” and “comprise” do not means the inclusion of only the listed items but rather the inclusion of only the listed items or the inclusion of additional items in addition to the listed items. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation and the like can be made without departing from the gist of the present disclosure.

### (4) Supplements

Characteristics relating to the embodiments described above are described as supplements.

### Supplement 1

A relay apparatus for use in a mobile communication system, the relay apparatus including:
a relay configured to relay a radio signal transmitted between a base station and a user equipment, and
a control terminal configured to perform wireless communication with the base station to control the relay, wherein
a first frequency used in a control link between the base station and the control terminal is different from a second frequency used in a backhaul link between the base station and the relay, and
the control terminal is configured to transmit information on the second frequency to the base station via the control link.

### Supplement 2

The relay apparatus according to supplement 1, further including:
a receiver configured to receive a radio signal transmitted at the second frequency from the base station, wherein
the control terminal is configured to transmit information on the second frequency to the base station via the control link, based on the radio signal received by the receiver.

### Supplement 3

The relay apparatus according to supplement 2, wherein
the receiver is configured to receive, as the radio signal, an SSB (SS/PBCH Block) transmitted at the second frequency from the base station.

### Supplement 4

The relay apparatus according to any one of supplements 1 to 3, wherein the second frequency is a frequency higher than the first frequency.

### Supplement 5

The relay apparatus according to any one of supplements 1 to 4, wherein
the control terminal is configured to transmit, to the base station via the control link, capability information regarding a capability of the control terminal to use the second frequency, and the capability includes a capability of the control terminal to establish the control link at the second frequency and/or a capability of the control terminal to receive and/or process a radio signal transmitted at the second frequency from the base station.

### Supplement 6

The relay apparatus according to any one of supplements 1 to 5, wherein
the control terminal is configured to transmit, to the base station via the control link, information indicating a beam satisfying a predetermined reception quality criterion at the second frequency or information indicating a beam not satisfying the predetermined reception quality criterion at the second frequency.

### Supplement 7

The relay apparatus according to supplement 6, wherein
the control terminal is configured to transmit a set of the information indicating the beam and a frequency identifier to the base station via the control link.

### Supplement 8

The relay apparatus according to supplement 6 or 7, wherein
in response to detection of a beam having better reception quality than that of a selected beam at the second frequency, the control terminal is configured to transmit information indicating the beam detected to the base station via the control link.

### Supplement 9

The relay apparatus according to any one of supplements 1 to 8, wherein
the control terminal is configured to:
measure a channel state at the second frequency; and
transmit feedback information indicating the measured channel state to the base station via the control link.

### Supplement 10

A relay apparatus for use in a mobile communication system includes
a relay configured to relay a radio signal transmitted between a cell of a base station and a user equipment, and
a control terminal configured to perform wireless communication with the base station to control the relay, wherein
the control terminal is configured to communicate information indicating a beam of a neighboring cell different from the cell with the base station via the control link.

### Supplement 11

The relay apparatus according to supplement 10, wherein
the control terminal is configured to:
receive the information indicating the beam of the neighboring cell from the base station via the control link; and
perform processing of receiving the beam of the neighboring cell based on the received information.

### Supplement 12

The relay apparatus according to supplement 10 or 11, wherein
the control terminal is configured to:
specify an interference beam, the interference beam being a beam of the neighboring cell and being an interference source; and
transmit information indicating the specified interference beam to the base station via the control link.

### Supplement 13

A relay apparatus for use in a mobile communication system, the relay apparatus including:
a relay configured to relay a radio signal transmitted between a cell of a base station and a user equipment, and
a control terminal configured to perform wireless communication with the base station to control the relay, wherein
the control terminal is configured to transmit information indicating a desired number of beams formed by the relay for an access link between the relay and the user equipment, to the base station via the control link.

### REFERENCE SIGNS

1 Mobile communication system
100 UE
200 gNB
210 Transmitter
220 Receiver
230 Controller
240 Backhaul communicator
500A NCR apparatus
500B RIS apparatus
511A Wireless unit
511a Antenna unit
511b RF circuit
511c Directivity controller
512A NCR controller
512B RIS controller
521 Receiver
522 Transmitter
523 Controller
530 Interface
540 Receiver

1. A relay apparatus for use in a mobile communication system, the relay apparatus comprising:
a relay configured to relay a radio signal transmitted between a network node and a user equipment; and
a control terminal configured to perform wireless communication with the network node to control the relay, wherein
a first frequency used in a control link between the network node and the control terminal is different from a second frequency used in a backhaul link between the network node and the relay, and
the control terminal is configured to transmit information on the second frequency to the network node via the control link.

2. The relay apparatus according to claim 1, further comprising
a receiver configured to receive a radio signal transmitted at the second frequency from the network node, wherein
the control terminal is configured to transmit information on the second frequency to the network node via the control link, based on the radio signal received by the receiver.

3. The relay apparatus according to claim 2, wherein
the receiver is configured to receive, as the radio signal, an SSB (SS/PBCH Block) transmitted at the second frequency from the network node.

4. The relay apparatus according to claim 1, wherein
the second frequency is a frequency higher than the first frequency.

5. The relay apparatus according to claim 1, wherein
the control terminal is configured to transmit, to the network node via the control link, capability information regarding a capability of the control terminal to use the second frequency, and
the capability comprises a capability of the control terminal to establish the control link at the second frequency and/or a capability of the control terminal to receive and/or process a radio signal transmitted at the second frequency from the network node.

6. The relay apparatus according to claim 1, wherein
the control terminal is configured to transmit, to the network node via the control link, information indicating a beam satisfying a predetermined reception quality criterion at the second frequency or information indicating a beam not satisfying the predetermined reception quality criterion at the second frequency.

7. The relay apparatus according to claim 6, wherein
the control terminal is configured to transmit a set of the information indicating the beam and a frequency identifier to the network node via the control link.

8. The relay apparatus according to claim 6, wherein
in response to detection of a beam having better reception quality than that of a selected beam at the second frequency, the control terminal is configured to transmit information indicating the beam detected to the network node via the control link.

9. The relay apparatus according to claim 1, wherein
the control terminal is configured to:
measure a channel state at the second frequency; and
transmit feedback information indicating the measured channel state to the network node via the control link.

10. A relay apparatus for use in a mobile communication system, the relay apparatus comprising:
a relay configured to relay a radio signal transmitted between a cell of a network node and a user equipment; and
a control terminal configured to perform wireless communication with the network node to control the relay, wherein
the control terminal is configured to communicate information indicating a beam of a neighboring cell different from the cell with the network node via the control link.

11. The relay apparatus according to claim 10, wherein
the control terminal is configured to:
receive the information indicating the beam of the neighboring cell from the network node via the control link; and
perform processing of receiving the beam of the neighboring cell based on the received information.

12. The relay apparatus according to claim 10, wherein
the control terminal is configured to:
specify an interference beam, the interference beam being a beam of the neighboring cell and being an interference source; and
transmit information indicating the specified interference beam to the network node via the control link.

13. A relay apparatus for use in a mobile communication system, the relay apparatus comprising:
a relay configured to relay a radio signal transmitted between a cell of a network node and a user equipment; and
a control terminal configured to perform wireless communication with the network node to control the relay, wherein
the control terminal is configured to transmit information indicating a desired number of beams formed by the relay for an access link between the relay and the user equipment, to the network node via the control link.
